(19) United States
(12) Patent Application Publication
(10) Pub. No.: US 2024/0311616 A1
(43) Pub. Date: Sep. 19, 2024

(54) MACHINE LEARNING MODELS FOR PROCESSING DATA FROM DIFFERENT VEHICLE PLATFORMS

(71) Applicant: GM Cruise Holdings LLC, San Francisco, CA (US)

(72) Inventor: Burkay Donderici, Burlingame, CA (US)

(21) Appl. No.: 18/183,693

(22) Filed: Mar. 14, 2023

(51) Int. Cl. G06N 3/0455; B60W 50/06; G06N 3/0475; G06N 3/094; G07C 5/08

(52) U.S. Cl. CPC G06N 3/0455; B60W 50/06; G06N 3/0475; G06N 3/094; G07C 5/0808; B60W 2420/403; B60W 2420/408; B60W 2420/54

(57) ABSTRACT

Systems and techniques are provided for mapping data from a vehicle platform to a different vehicle platform. An example method can include obtaining sensor data collected by an autonomous vehicle (AV) in a scene, the AV comprising a target vehicle platform, the sensor data describing, measuring, or depicting one or more elements in the scene; determining one or more differences between the sensor data associated with the target vehicle platform and additional sensor data associated with a reference vehicle platform, the reference vehicle platform being associated with one or more software models that are trained to process data from the reference vehicle platform; based on the one or more differences, mapping the sensor data associated with the target vehicle platform to the reference vehicle platform; and processing the mapped sensor data via the one or more software models.

### TECHNICAL FIELD

The present disclosure generally relates to models implemented by autonomous vehicles to process sensor data. For example, aspects of the present disclosure relate to systems and techniques for processing data from different vehicle platforms and configuring a model(s) to convert, map, project, process, and/or translate data from different vehicle platforms according to on one or more aspects and/or characteristics of data from a reference vehicle platform.

### BACKGROUND

An autonomous vehicle is a motorized vehicle that can navigate without a human driver. An exemplary autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Typically, the sensors are mounted at specific locations on the autonomous vehicles.

### BRIEF DESCRIPTION OF THE DRAWINGS

Illustrative examples and aspects of the present application are described in detail below with reference to the following figures:

FIG. 1 is a diagram illustrating an example system environment that can be used to facilitate autonomous vehicle (AV) navigation and routing operations, in accordance with some examples of the present disclosure;

FIG. 2 is a diagram illustrating an example simulation framework for simulating scenes navigated by autonomous vehicles, according to some examples of the present disclosure;

FIG. 3 is a diagram illustrating an example system for processing data from different vehicle platforms, according to some examples of the present disclosure;

FIG. 4 is a diagram illustrating an example generative adversarial network model, according to some examples of the present disclosure;

FIG. 5 is a diagram illustrating example discriminator network model, according to some examples of the present disclosure;

FIG. 6 is a diagram illustrating an example configuration of a neural network model, according to some examples of the present disclosure;

FIGS. 7A through 7B are diagrams illustrating example images collected from different vehicle platforms, according to some examples of the present disclosure;

FIG. 7C is a diagram illustrating example image mapped from one vehicle platform to a different vehicle platform, according to some examples of the present disclosure;

FIG. 8 is a flowchart illustrating an example process for mapping data from a vehicle platform to a different vehicle platform, according to some examples of the present disclosure; and

FIG. 9 is a diagram illustrating an example system architecture for implementing certain aspects described herein.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of aspects and examples of the application. However, it will be apparent that various aspects and examples may be practiced without these specific details. The figures and description are not intended to be restrictive.

The ensuing description provides aspects and examples of the disclosure, and is not intended to limit the scope, applicability, or configuration of the disclosure. Rather, the ensuing description of the aspects and examples of the disclosure will provide those skilled in the art with an enabling description for implementing an example implementation of the disclosure. It should be understood that various changes may be made in the function and arrangement of elements without departing from the scope of the application as set forth in the appended claims.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

As previously explained, autonomous vehicles (AVs) can include various sensors, such as a camera sensor, a light detection and ranging (LIDAR) sensor, a radio detection and ranging (RADAR) sensor, an inertial measurement unit (IMU), and/or an acoustic sensor (e.g., sound navigation and ranging (SONAR), microphone, etc.), global navigation satellite system (GNSS) and/or global positioning system (GPS) receiver, amongst others. The AVs can use the various sensors to collect data and measurements that the AVs can use for AV operations such as perception (e.g., object detection, event detection, tracking, localization, sensor fusion, point cloud processing, image processing, etc.), planning (e.g., route planning, trajectory planning, situation analysis, behavioral and/or action planning, mission planning, etc.), control (e.g., steering, braking, throttling, lateral control, longitudinal control, model predictive control (MPC), proportional-derivative-integral, etc.), prediction (e.g., motion prediction, behavior prediction, etc.), etc. The sensors can provide the data and measurements to an internal computing system of the autonomous vehicle, which can use the data and measurements to control a mechanical system of the autonomous vehicle, such as a vehicle propulsion system, a braking system, and/or a steering system, for example.

The various sensors implemented by an AV can be placed (e.g., mounted, embedded, attached, positioned, etc.) at specific locations of the AV. During operation, a sensor on the AV can have a fixed orientation relative to the AV or can be repositioned to any of a set of orientations (e.g., a range of orientations, a sequence of orientations, a set of predetermined orientations, etc.) relative to the AV. The location and orientation of a sensor on the AV can affect one or more aspects of operation of the sensor and characteristics of the data captured by the sensor. For example, the location and orientation of a sensor on the AV can affect the field-of-view (FOV) of the sensor, the perspective of the sensor, and/or certain characteristics of the data captured by the sensor. As another example, the location and orientation of a sensor on the AV can affect whether a visibility of the sensor to any area within the FOV of the sensor (e.g., an area within a scene of the AV, an internal area of the AV, and/or an external area of the AV) is blocked or impaired by any occlusions located within the FOV of the sensor, such as one or more objects or pedestrians (e.g., inside and/or outside of the AV) relative to the sensor.

Moreover, AVs can have different AV platforms, which can impact certain aspects of the sensors on the AVs and the data captured by the sensors. The different AV platforms can include different AV body types, dimensions, shapes, and/or sizes. Given the different AV body types, dimensions, shapes, and/or sizes of the AV platforms, the sensors in an AV platform, and the data from such sensors, can have different characteristics than the sensors in a different AV platform and the data from those sensors. For example, the AV body type, dimensions, shape, and/or size of an AV platform can affect the position (e.g., location and/or orientation) of sensors on that AV platform relative to one or more elements in a scene (e.g., relative to a ground, an object, a pedestrian, a scene, an interior of the AV, an exterior of the AV, etc.), which can affect the FOV, visibility/occlusions, perspective, coverage, and/or other characteristics of the sensors. The position of the sensors on the AV platform relative to the one or more elements can also affect various characteristics of the data captured by the sensors, such as a perspective of the data, a content reflected in the data, an occlusion(s) reflected in the data, a view represented in the data, an area covered by the data, etc. Accordingly, the characteristics of the sensors on a particular AV platform and the data captured by those sensors can differ from the characteristics of the sensors on a different AV platform and the data from those sensors.

To illustrate, the dimensions/geometry of an AV platform of an AV can differ from the dimensions/geometry of a different AV platform of another AV. The difference in the dimensions/geometry of the AV platforms can create differences in the FOVs, perspectives, placements, visibilities, occlusions, sensor data, etc., of the sensors on the different AV platforms. Consequently, the data captured by sensors on an AV platform can differ from the data captured by sensors on a different AV platform. For example, the data captured by a sensor on an AV platform can have a different FOV, perspective, view/visibility, occlusion (or lack thereof) and/or coverage than the data captured by another sensor on a different AV platform. To illustrate, a sensor on an AV platform may have visibility to an object in a scene given the position of the sensor (e.g., on the AV platform) relative to the object in the scene and the FOV of the sensor. On the other hand, a sensor on a different AV platform may not have a view to the object (or may have a different view to the object) because of the position (e.g., on the different AV platform) of that sensor relative to the object and/or relative to one or more occlusions (e.g., an occluding object, an occluding structure, an occluding environmental condition such as a lighting or weather condition, an occluding portion of the different AV platform, an occluding pedestrian, etc.) within a path between the sensor on the different AV platform and the object.

Therefore, the data captured by the sensor on the AV platform can differ from the data captured by the other sensor on the different AV platform. In some cases, the data from sensors on different AV platforms can represent, depict, measure, describe, relate, and/or probe different objects in a scene, different conditions in the scene, different events in the scene, different attributes of the scene, different perspectives of the scene, different perspectives of an object in the scene, and/or different portions of the scene, among others. The data from the sensors on the different AV platforms can additionally or alternatively have different perspectives (e.g., relative to the AV platforms and/or a scene associated with the AV platforms), different associated FOVs, different occlusions (e.g., if any), different features, different attributes (e.g., different lighting, different coverage, different views, etc.), different data (e.g., different measurements, different depictions, different values, different patterns, different datapoints, etc.), and/or any other distinctions.

The AVs can use the data captured by the sensors on the AVs to perform various AV operations. Non-limiting examples of AV operations can include object detection, object tracking, scene kinematics estimation, AV localization, routing, planning (e.g., route planning, maneuver planning, operations planning, etc.), control operations, and predictions such as, for example, predicted trajectories of scene agents (e.g., vehicles, objects, animals, pedestrians, other road users, etc.), predicted interactions with scene agents, scene contextual right-of-way yield and/or assert probabilities, cost fields, etc. Moreover, the AVs can implement various types of software components (e.g., algorithms, models, software stacks, nodes, etc.) configured to perform specific AV operations based on the data captured by the sensors on the AVs. For example, the AVs can implement a perception stack, a planning stack, a prediction stack, a control stack, and/or a localization stack to perform specific AV operations based on the data from the sensors on the AVs.

In some cases, the software stacks of an AV (e.g., perception stack, planning stack, prediction stack, control stack, localization stack, etc.) can be configured to process, understand, interpret, and/or use data from sensors on a particular AV platform (e.g., a sedan, a convertible, a coupé, a hatchback, a minivan, a limousine, a truck, a station wagon, a bus, etc.), which can have specific dimensions (e.g., a specific shape, a specific height, a specific length, a specific width, etc.), specific placements of sensors, a specific number and/or type of sensors, etc. Moreover, the software stacks of an AV can be configured to process, understand, interpret, and/or use data from sensors with specific characteristics and/or configurations (e.g., specific locations and/or orientations (fixed or adjustable) within the AV platform, a specific range of locations and/or orientations within the AV platform, specific motion (e.g., rotational motion, translational motion, etc.), specific FOVs, specific views/visibilities of one or more portions of the AV and/or the AV platform, specific rates of operation such as frame rates, specific measurement capabilities, specific resolution capabilities, specific occlusions, specific coverages, etc.). The characteristics and/or configurations of the sensors and/or the data from the sensors can be affected by the AV platform implementing such sensors, as previously described.

The software stacks of the AV can additionally or alternatively be trained using data that has the same and/or similar characteristics as data from the sensors on the particular AV platform, data from sensors having the same and/or similar characteristics and/or configurations as the sensors on the particular AV platform, the same (or similar) type of data as the data from the sensors on the particular AV platform, data captured by sensors on the particular AV platform, data having a same or similar context as data from sensors on the particular AV platform, and/or data captured by sensors in a same or similar context as the sensors of the particular AV platform.

In some cases, an AV having a particular AV platform can implement one or more models (e.g., one or more machine learning models) that are designed and/or trained to handle sensor data associated with the particular AV platform (e.g., sensor data captured in the context of the particular AV platform). For example, the one or more models can be designed and/or trained to handle sensor data from sensors having specific placements (e.g., location and/or orientation) on the AV platform, sensors having specific perspectives from a position of the sensors on the particular AV platform relative to other things in a scene of the AV, and/or sensor data specific to a context of the sensors that captured the sensor data, such as the particular AV platform of the sensors (e.g., sensor data having certain content and/or attributes affected by or attributed to the particular AV platform (e.g., the body type, dimensions, size, shape, etc.) implementing the sensors that captured such sensor data). In some examples, sensor data specific to a context, such as sensor data specific to the particular AV platform, can have or reflect a specific FOV, perspective, occlusion (or lack thereof), view, and/or content that can at least partly depend on the context (e.g., the body type of the particular AV platform, the dimensions (e.g., size, shape, etc.) of the particular AV platform, etc.) of the sensors used to capture such sensor data.

In some cases, a model designed and/or trained to handle sensor data captured in the context of a particular AV platform can have difficulty handling, or may not be able to handle, sensor data associated with a different type of AV platform(s) (e.g., sensor data captured by sensors on a different type of AV platform(s)). For example, if a machine learning model is tailed to handle sensor data captured by sensors on a specific AV platform, the machine learning model may not be able to handle or may have difficulty handling sensor data captured by sensors on a different type of AV platform (e.g., an AV platform having a different body type, size, dimensions, shape, etc.). In some examples, the machine learning model may not support, may not be suited to handle, and/or may have lower metrics (e.g., lower performance metrics, lower accuracy metrics, lower efficiency metrics, lower cost metrics, etc.) when handling or attempting to handle sensor data from sensors on the different type of AV platform(s) than when handling sensor data from sensors on the particular AV platform that the machine learning model was designed and/or trained for.

Moreover, it can be more expensive (e.g., in terms of time, resources, and/or cost) and impractical to design and/or train multiple versions of a model for different types of AV platforms. For example, if there are n number (where n is greater than 1) of AV platforms that may implement (and/or may be selected to implement) a machine learning model, such as a machine learning model used by an AV planning stack, localization stack, prediction stack, control stack, or perception stack, it can be more expensive and impractical to train and/or configure the machine learning model for the n number of AV platforms or generate n number of versions of the machine learning model with each version being trained and/or configured for a respective AV platform from the n number of AV platforms. In addition, it may be otherwise undesirable to implement a machine learning model trained and/or configured for a particular AV platform on other types of AV platforms, as the machine learning model may have a lower performance, efficiency, accuracy, cost, and/or capacity with respect to sensor data corresponding to the other types of AV platforms (e.g., with respect to sensor data captured by sensors on the other types of AV platforms). Further, in some cases, the near-field data distribution of sensor data can be different for different AV platforms (e.g., different vehicle body types, shapes, dimensions, and/or sizes). However, re-training models (e.g., machine learning models) for different AV platforms can be expensive and time-consuming.

The challenges and disadvantages of training a machine learning model to handle data from sensors in different AV platforms or creating different versions of a machine learning model tailored for different AV platforms (e.g., tailored to handle data from sensors in different AV platforms) can be exacerbated by the complexity of machine learning models used by AVs. For example, a machine learning model implemented by an AV can include a very complex model, such as a neural network(s), and can perform complex machine learning operations. Non-limiting examples of neural networks and associated operations that can be used by an AV can include a convolutional neural network (CNN), a residual neural network (ResNet), a U-Net (e.g., a fully convolutional network), a PointNet, a transformer neural network, a classification network, convolution operations, deconvolution operations, down-sampling, up-sampling, data transforms, pooling, classification, segmentation, image processing, and/or other components and operations. Typically, a machine learning model is trained using a supervised training scheme where the model predicts previously-collected labels and/or previously-labeled data, or a self-supervised training scheme where the model is fed unstructured data and generates labels that it uses as ground truths in subsequent iterations.

In supervised training schemes, a machine learning model of an AV can be trained with a training dataset that contains and/or reflects static and/or dynamic information relevant to the AV, such as a semantic map, street signs, traffic light states, observations and/or parameters of scene agents (e.g., kinematics of scene agents, visual features associated with scene agents, behaviors and/or associated probabilities of scene agents, etc.), sensor data, AV information, sensor extrinsics (e.g., position and orientation), sensor intrinsics (e.g., focal length, aperture, FOV, resolution, framerate, etc.), scene information, and/or other data from an AV software stack(s) (e.g., perception stack, planning stack, localization stack, prediction stack, control stack, etc.), a semantic map, etc. The scene of the AV can include or be made up of such dynamic and/or static information (e.g., and/or the associated scene elements/objects). Some of the data can depend on (and/or can be specific to or vary based on) the specific AV platform of an AV that collected such data. For example, the sensor extrinsics (e.g., position and orientation) and the AV information (e.g., body type, dimensions, shape, configuration, size, etc.) can depend on the specific AV platform on the AV that collected such data. The sensor data, which can measure, depict, describe, and/or represent aspects of a scene such as visual elements (e.g., objects, vehicles, pedestrians, signs, road markings, crosswalks, etc.) and motion in the scene, can have or include content and attributes that may depend on (and/or be affected by) the AV platform (e.g., body type, dimensions, shape, size, configuration, etc.) of the AV used to capture the sensor data.

The complexity of machine learning models used by AVs and training such machine learning models illustrates the challenges and disadvantages (e.g., cost, time, complexity, inefficiency, etc.) of training a machine learning model to handle sensor data from different AV platforms (e.g., from sensors on different AV platforms, from sensors with certain parameters such as sensor extrinsics that are affected by and/or specific to a respective AV platform(s), etc.) or developing multiple versions of a machine learning model that are trained to handle sensor data from different AV platforms. Moreover, the machine learning models implemented by AVs are often tested using complex simulation frameworks. The simulation frameworks can run simulations of specific test scenarios, which can be used to test, troubleshoot, and/or validate the AV software, such as the machine learning models. The simulations can be expensive in terms of time and compute cost, and may not be feasible for all scenarios. The difficulty and disadvantages of training a machine learning model to handle sensor data from different AV platforms or developing multiple versions of a machine learning model that are trained to handle sensor data from different AV platforms can thus be further exacerbated in cases where simulations are used (and/or needed) to test, troubleshoot, and/or validate the machine learning models used by AVs.

For at least the foregoing reasons, it may be desirable to develop and/or enable models that can handle sensor data from different AV platforms. By enabling a model to handle sensor data from different AV platforms, the model can be implemented in AVs with different AV platforms without recreating and/or retraining the model for each of the different AV platforms. Moreover, by enabling a model to handle sensor data from different AV platforms, a developer can avoid having to develop a version of a model for each AV platform or retrain a model for each AV platform, which can result in numerous benefits such as reduced cost, increased efficiency, reduced time (e.g., a reduction of time that would otherwise incurred in developing different versions of a model or re-training/revalidating a model for different AV platforms), etc.

Systems, apparatuses, processes (also referred to as methods), and computer-readable media (collectively referred to as “systems and techniques”) are described herein for developing vehicle software capable of handling sensor data from sensors in different vehicle platforms (e.g., different AV platforms including different body types, dimensions, configurations, shapes, sizes, etc.) and/or configuring vehicle software to handle sensor data from sensors in different vehicle platforms. In some examples, the systems and techniques described herein can be used to process sensor data from sensors on different vehicle platforms and configuring a model(s) to convert, map, project, process, and/or translate sensor data from different vehicle platforms according to on one or more aspects and/or characteristics of the sensor data from a reference vehicle platform. For example, in some cases, instead of retraining (and/or performing a full training) a machine learning model to handle data from different vehicle platforms, the systems and techniques described herein can map the data from one vehicle platform (e.g., from a particular body type, a particular shape, a particular size, a particular configuration, particular dimensions, etc.) to appear like and/or match data from another vehicle platform (e.g., from another body type, shape, size, configuration, dimensions, etc.), such as a reference vehicle platform.

The systems and techniques described herein can map data from any particular sensor or combination of sensors on a vehicle platform to appear like and/or match data from the particular sensor or the combination of sensors on another vehicle platform. For example, the systems and techniques described herein can map image data (e.g., data from a camera sensor) from a target vehicle platform to appear like and/or match image data (e.g., data from the camera sensor) from a reference vehicle platform. Similarly, the systems and techniques described herein can map light detection and ranging (LIDAR) data (e.g., data from a LIDAR sensor) from a target vehicle platform to appear like and/or match LIDAR data (e.g., data from the LIDAR sensor) from a reference vehicle platform. As another example, the systems and techniques described herein can map radio detection and ranging (RADAR) data (e.g., data from a RADAR sensor) from a target vehicle platform to appear like and/or match RADAR data (e.g., data from the RADAR sensor) from a reference vehicle platform. As yet another example, the systems and techniques described herein can map fused sensor data (e.g., data from a camera sensor, a LIDAR, a RADAR, and/or any other sensor) from a target vehicle platform to appear like and/or match fused sensor data (e.g., data from the camera sensor, the LIDAR, the RADAR, and/or the other sensor) from a reference vehicle platform, or appear like and/or match sensor data from the reference vehicle platform and captured by one of the sensors used to create the fused sensor data (e.g., data of a camera sensor, a LIDAR, a RADAR, or another sensor).

In some examples, the systems and techniques described herein can determine one or more characteristics of data (e.g., content, FOV, perspective, occlusions, conditions, pose (e.g., position and orientation), etc.) from a reference vehicle platform, and map (e.g., convert, modify, translate or transform, etc.) data from a target vehicle platform to include and/or match the one or more characteristics of the data from the reference vehicle platform. In some aspects, to map data from a vehicle platform to appear like and/or match data from another vehicle platform, the systems and techniques described herein can implement a generative adversarial network (GAN) trained to map sensor data (e.g., camera data, LIDAR data, RADAR data, and/or any other sensor data) from one vehicle platform to a different vehicle platform. For example, the systems and techniques described herein can train a GAN model to map sensor data from a vehicle body type to a different vehicle body type. In some cases, the GAN model can be trained with simulation data from different vehicle platforms (e.g., from different vehicle body types, shapes, sizes, configurations, dimensions, etc.).

In some examples, to map data from a vehicle platform to a different vehicle platform, the systems and techniques described herein can use software architectures (e.g., neural network architectures, etc.) that share the same layers but also include one or more additional layers configured to adapt the algorithms to different vehicle types (e.g., different body types, shapes, sizes, configurations, dimensions, etc.). For example, the systems and techniques described herein can use neural network architectures that share the same layers but also include one or more additional layers at a beginning of the neural networks (e.g., as input layers, as first layers, as higher layers used prior to deeper layers, etc.), which can be configured to process the raw data (e.g., the raw sensor data) and learn how to handle/process the data for specific vehicle platforms.

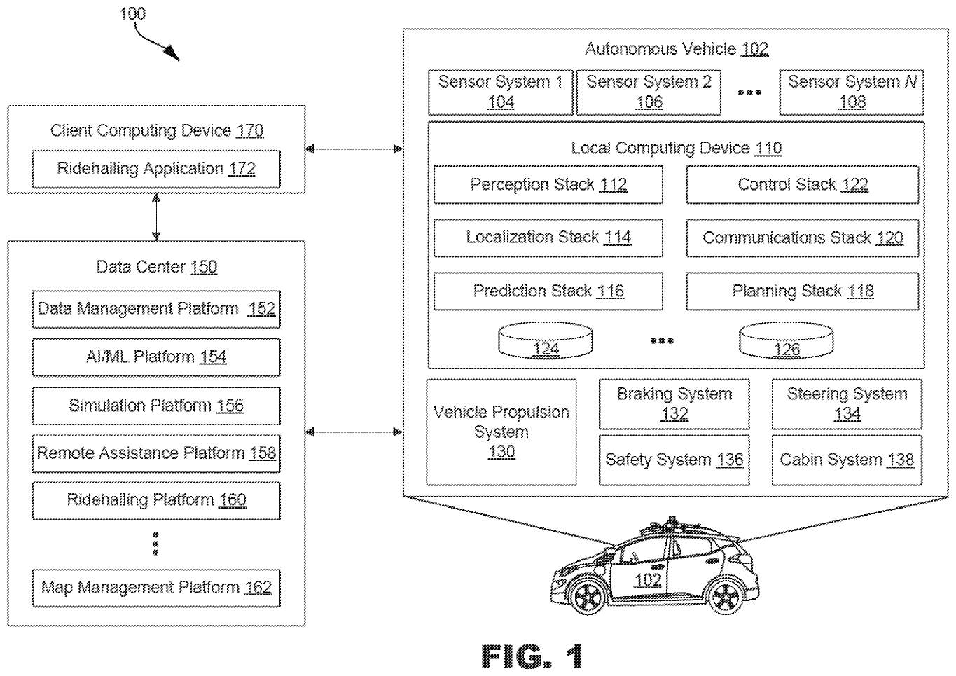

Examples of the systems and techniques described herein are illustrated in FIG. 1 through FIG. 9 and described below.

FIG. 1 is a diagram illustrating an example autonomous vehicle (AV) environment 100, according to some examples of the present disclosure. One of ordinary skill in the art will understand that, for the AV environment 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV environment 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by sensor systems 104, 106, and 108. The sensor systems 104-108 can include one or more types of sensors and can be arranged about the AV 102. For instance, the sensor systems 104-108 can include one or more inertial measurement units (IMUs), camera sensors (e.g., still image camera sensors, video camera sensors, etc.), light sensors (e.g., LIDARs, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, time-of-flight (TOF) sensors, seat occupancy sensors, open/closed door sensors, tire pressure sensors, rain sensors, and so forth. For example, the sensor system 104 can include a camera system, the sensor system 106 can include a LIDAR system, and the sensor system 108 can include a RADAR system. Other examples may include any other number and type of sensors.

The AV 102 can include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can include a local computing device 110 that is in communication with the sensor systems 104-108, the mechanical systems 130-138, the data center 150, and/or the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and/or other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can identify environmental uncertainties, such as where to look for moving objects, flag areas that may be obscured or blocked from view, and so forth. In some examples, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some cases, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some examples, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some examples, the HD maps and related data can include multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some examples, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridehailing platform 160, and a map management platform 162, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridehailing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridehailing platform 160, the map management platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from the map management platform 162 and/or a cartography platform; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridehailing platform 160 can interact with a customer of a ridesharing service via a ridehailing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ridehailing application 172. In some cases, the client computing device 170 can be a customer's mobile computing device or a computing device integrated with the AV 102 (e.g., the local computing device 110). The ridehailing platform 160 can receive requests to pick up or drop off from the ridehailing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some examples, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ridehailing platform 160 may incorporate the map viewing services into the client application 172 to enable passengers to view the AV 102 in transit to a pick-up or drop-off location, and so on.

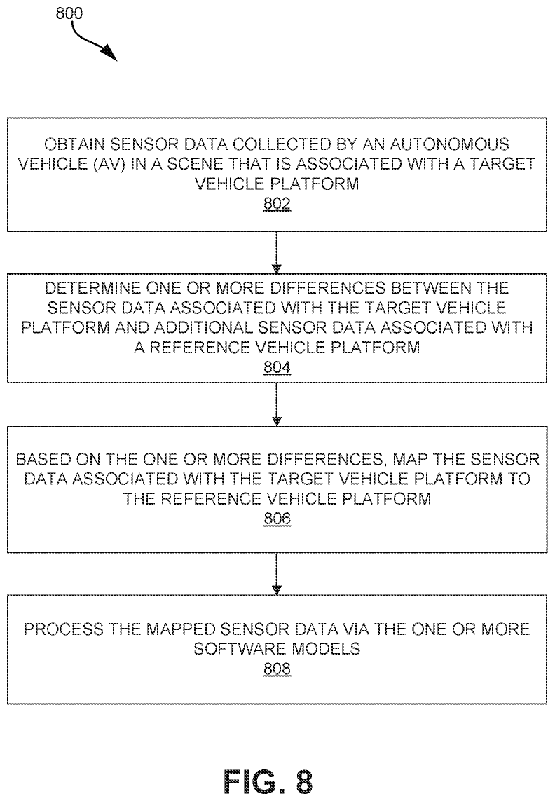

While the AV 102, the local computing device 110, and the autonomous vehicle environment 100 are shown to include certain systems and components, one of ordinary skill will appreciate that the AV 102, the local computing device 110, and/or the autonomous vehicle environment 100 can include more or fewer systems and/or components than those shown in FIG. 1. For example, the AV 102 can include other services than those shown in FIG. 1 and the local computing device 110 can, in some instances, include one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 8.

As previously explained, generally, the human visual cortex is able to understand or infer a geometric shape from a set of points representing such geometric shape. For example, a human looking at points within a polygon generally can involuntarily or subconsciously construct a shape associated with those points within the polygon as well as the interior and exterior of the shape. On the other hand, a neural network does not have such capacity by default. The neural network does not have such a human-like geometric intuition. In other words, a neural network by default may not be able to derive the shape or semantic meaning of a polygon representing a scene element (e.g., a crosswalk, a lane, a sidewalk, etc.) from an input comprising a set of points representing that polygon. However, the systems and techniques described herein can configure a neural network to use self-supervised training to learn and recognize such a shape (e.g., a crosswalk, a lane, a sidewalk, etc.) from a set of input points corresponding to such shape. For example, the systems and techniques described herein can configure a neural network to use self-supervised training to learn the semantic meaning of points/samples of a shape representing a scene element such as, for example, a crosswalk, an intersection, a traffic lane, an ingress or egress ramp, a sidewalk, etc.

In some examples, the systems and techniques described herein can generate a generative adversarial network (GAN) trained to map data from a vehicle platform to appear like and/or match data from a different vehicle platform, as previously explained. In some cases, the GAN model can be trained using simulation data, such as simulation data from different vehicle platforms.

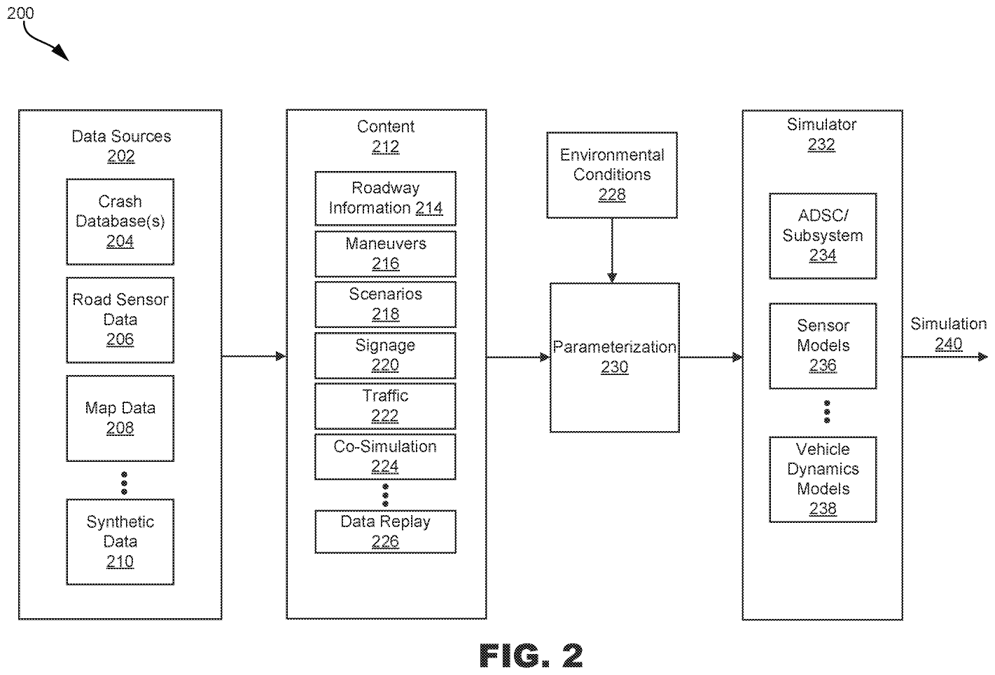

FIG. 2 is a diagram illustrating an example simulation framework 200 that can be used to train AV software described herein, such as GAN models used to map data from a vehicle platform to a different vehicle platform. The example simulation framework 200 can include data sources 202, content 212, environmental conditions 228, parameterization 230, and simulator 232. The components in the example simulation framework 200 are merely illustrative examples provided for explanation purposes. In other examples, the simulation framework 200 can include other components that are not shown in FIG. 2 and/or more or less components than shown in FIG. 2.

The data sources 202 can be used to create a simulation. For example, the data sources 202 can be used to simulate a particular data context such as a particular vehicle platform. The data sources 202 can include, for example and without limitation, one or more crash databases 204, road sensor data 206, map data 208, and/or synthetic data 210. In other examples, the data sources 202 can include more or less sources than shown in FIG. 2 and/or one or more data sources that are not shown in FIG. 2.

The crash databases 204 can include crash data (e.g., data describing crashes and/or associated details) generated by vehicles involved in crashes. The road sensor data 206 can include data collected by one or more sensors (e.g., one or more camera sensors, LIDAR sensors, RADAR sensors, SONAR sensors, IMU sensors, GPS/GNSS receivers, and/or any other sensors) of one or more vehicles while the one or more vehicles drive/navigate one or more real-world environments. The map data 208 can include one or more maps (and, in some cases, associated data) such as, for example and without limitation, one or more high-definition (HD) maps, sensor maps, scene maps, and/or any other maps. In some examples, the one or more HD maps can include roadway information such as, for example, lane widths, location of road signs and traffic lights, directions of travel for each lane, road junction information, speed limit information, etc.

The synthetic data 210 can include virtual assets, objects, and/or elements created for a simulated scene, a virtual scene and/or virtual scene elements, and/or any other synthetic data elements. For example, in some cases, the synthetic data 210 can include one or more virtual vehicles, virtual pedestrians, virtual roads, virtual objects, virtual environments/scenes, virtual signs, virtual backgrounds, virtual buildings, virtual trees, virtual motorcycles/bicycles, virtual obstacles, virtual environmental elements (e.g., weather, lightening, shadows, etc.), virtual surfaces, etc.

In some examples, data from some or all of the data sources 202 can be used to create the content 212. The content 212 can include static content and/or dynamic content. For example, the content 212 can include roadway information 214, maneuvers 216, scenarios 218, signage 220, traffic 222, co-simulation 224, and/or data replay 226. The roadway information 214 can include, for example, lane information (e.g., number of lanes, lane widths, directions of travel for each lane, etc.), the location and information of road signs and/or traffic lights, road junction information, speed limit information, road attributes (e.g., surfaces, angles of inclination, curvatures, obstacles, etc.), road topologies, and/or other roadway information. The maneuvers 216 can include any AV maneuvers, and the scenarios 218 can include specific AV behaviors in certain AV scenes/environments. The signage 220 can include signs such as, for example, traffic lights, road signs, billboards, displayed messages on the road, etc. The traffic 222 can include any traffic information such as, for example, traffic density, traffic fluctuations, traffic patterns, traffic activity, delays, positions of traffic, velocities, volumes of vehicles in traffic, geometries or footprints of vehicles, pedestrians, spaces (occupied and/or unoccupied), etc.

The co-simulation 224 can include a distributed modeling and simulation of different AV subsystems that form the larger AV system. In some cases, the co-simulation 224 can include information for connecting separate simulations together with interactive communications. In some cases, the co-simulation 224 can allow for modeling to be done at a subsystem level while providing interfaces to connect the subsystems to the rest of the system (e.g., the autonomous driving system computer). Moreover, the data replay 226 can include replay content produced from real-world sensor data (e.g., road sensor data 206).

The environmental conditions 228 can include any information about environmental conditions 228. For example, the environmental conditions 228 can include atmospheric conditions, road/terrain conditions (e.g., surface slope or gradient, surface geometry, surface coefficient of friction, road obstacles, etc.), illumination, weather, road and/or scene conditions resulting from one or more environmental conditions, etc.

The content 212 and the environmental conditions 228 can be used to create the parameterization 230. The parameterization 230 can include parameter ranges, parameterized scenarios, probability density functions of one or more parameters, sampled parameter values, parameter spaces to be tested, evaluation windows for evaluating a behavior of an AV in a simulation, scene parameters, content parameters, environmental parameters, etc. The parameterization 230 can be used by a simulator 232 to generate a simulation 240.

The simulator 232 can include a software engine(s), algorithm(s), neural network model(s), and/or software component(s) used to generate simulations, such as simulation 240. In some examples, the simulator 232 can include ADSC/subsystem models 234, sensor models 236, and a vehicle dynamics model 238. The ADSC/subsystem models 234 can include models, descriptors, and/or interfaces for the autonomous driving system computer (ADSC) and/or ADSC subsystems such as, for example, a perception stack (e.g., perception stack 112), a localization stack (e.g., localization stack 114), a prediction stack (e.g., prediction stack 116), a planning stack (e.g., planning stack 118), a communications stack (e.g., communications stack 120), a control stack (e.g., control stack 122), a sensor system(s), and/or any other subsystems.

The sensor models 236 can include mathematical representations of hardware sensors and an operation (e.g., sensor data processing) of one or more sensors (e.g., a LIDAR, a RADAR, a SONAR, a camera sensor, an IMU, and/or any other sensor). The vehicle dynamics model 238 can model vehicle behaviors/operations, vehicle attributes, vehicle trajectories, vehicle positions, etc.

In some cases, the simulation framework 200 can be used to generate simulation data used to train and/or configure a model(s) to map data (e.g., road sensor data 206, data from sensor system 104, data from sensor system 106, data from sensor system 108, etc.) collected from one or more sensors on a first vehicle platform, such as an AV platform, to a second vehicle platform (e.g., to data from one or more sensors on the second vehicle platform), such as a different AV platform. For example, the model(s) can change one or more portions and/or attributes of first data collected from sensors on the first vehicle platform to match one or more portions and/or attributes of second data collected from sensors on the second vehicle platform given the same environment in which the first data associated with the first vehicle platform was collected (e.g., given the simulation data which includes and simulates one or more aspects of a scene in which the first data was collected). In some examples, the model(s) can map the data from the first vehicle platform to the second vehicle platform by adjusting the data to appear as if the data was collected from one or more sensors on the second vehicle platform and/or by determining what adjustments to the data are needed to make the data appear as if the data was collected by one or more sensors on the second vehicle platform.

The simulation data can simulate the conditions in which the data collected from the one or more sensors on the first vehicle platform was collected such as, for example and without limitation, a scene, a condition(s) in the scene (e.g., weather, traffic, light conditions, road conditions, etc.), kinematics of any agents in the scene, a state of the first vehicle platform (e.g., a location, an orientation, a speed, a direction of travel or trajectory, an acceleration/deceleration, an elevation/altitude, an operation and/or behavior, and/or other conditions), and/or any other conditions. In some cases, the conditions (e.g., and/or the simulation data) in which the data from the one or more sensors on the first vehicle platform was collected can additionally include a size of the first vehicle platform, a body type of the first vehicle platform, a dimension(s) of the first vehicle platform, a configuration of the first vehicle platform, a size of the first vehicle platform, and/or any other attributes of the first vehicle platform.

The model(s) used to map the data can be trained and configured to process and handle data from the second vehicle platform. In other words, the second vehicle platform can include a vehicle platform associated with data that the model(s) is trained to process and handle. For example, the model(s) can be trained and configured to process and handle data (e.g., from one or more sensors on the second vehicle platform) depicting a scene from a perspective of one or more sensors on the second vehicle platform (e.g., from a perspective of the one or more sensors given one or more characteristics of the second vehicle platform such as, for example, the body type of the second vehicle platform, the size of the second vehicle platform, the shape of the second vehicle platform, the dimensions of the second vehicle platform, a configuration of the second vehicle platform, an environment(s) of the second vehicle platform, etc.) and/or depicting (e.g., the scene depicting) at least a portion of the second vehicle platform (e.g., a portion of an interior and/or an exterior of the second vehicle platform) and/or a portion of an environment outside of the second vehicle platform (e.g., an environment external to the second vehicle platform).

To illustrate, the model(s) can process and understand the sensor data from the first vehicle platform, how to process and/or manipulate such sensor data, any attributes of such sensor data (and/or what attributes to expect from such sensor data), and/or how to generate outputs based on such sensor data. In some examples, a model trained to handle data from a particular vehicle platform can understand such data (e.g., understand conditions, parameters, details, content, etc., of the data), analyze such data, generate outputs from such data, perform one or more functions based on such data (e.g., object detection, tracking, localization, image processing, object recognition, scene recognition, predictions, event detection and recognition, etc.); apply one or more models, algorithms, and/or functions to such data; understand and process a format of such data; convert and/or transform such data; etc.

Since the model(s) is trained and configured to process and handle data from the second vehicle platform, by mapping the sensor data collected from one or more sensors of the first vehicle platform to the second vehicle platform as previously described, the model(s) can process and handle the data from the first vehicle platform. For example, the model(s) can process and handle the mapped data from the first vehicle platform to the second vehicle platform (e.g., the data from the first vehicle platform after being mapped to the second vehicle platform) and/or use the mapping of the data from the first vehicle platform to the second vehicle platform to process and handle the data from the first vehicle platform. In some cases, the model(s) can be configured to map data from other vehicle platforms to the second vehicle platform and process and handle the data from the other vehicle platforms (and/or the mapped data) as previously explained.

In some examples, the model(s) can be trained and/or configured to interpret, process, analyze, understand, and/or manipulate data from sensors on multiple vehicle platforms by mapping data from any vehicle platform to a base or reference vehicle platform. In some examples, the model(s) can map the data from a particular vehicle platform to the base or reference vehicle platform by converting and/or transforming the data from the particular vehicle platform to mirror, appear as, reflect, and/or match data from the base or reference platform collected given one or more conditions in which the data from the particular vehicle platform was collected (e.g., by making the data appear as if such data was captured by sensors on the base or reference platform). The model(s) can be trained and configured to process and handle data from the base or reference vehicle platform. Thus, by mapping data from any vehicle platform to the base or reference vehicle platform, the model(s) can process and handle data in/from any vehicle platform rather than being limited to a particular vehicle platform. Moreover, by implementing such a model(s) capable of handling (e.g., processing, understanding, interpreting, translating, adapting, transforming, applying, converting, analyzing, mapping, etc.) data from sensors on multiple (or any) vehicle platforms, developers can avoid having to develop a different model for each vehicle platform and/or retrain a model for each vehicle platform. Consequently, such a model(s) can provide significant savings, such as savings in terms of time, resources, cost, testing, and/or processing.

A vehicle platform can include, for example and without limitation, a vehicle body type, a vehicle size, a vehicle shape, a vehicle configuration, vehicle dimensions, a vehicle frame, vehicle components, one or more expected occlusions (e.g., one or more things occluded by something within a scene of the vehicle platform such as a passenger, a device, a portion of the vehicle platform, etc.), one or more sensor mounts (e.g., one or more mounts having a respective pose relative to the vehicle platform) and/or sensor platforms, etc. Thus, different vehicle platforms can include different vehicle body types, vehicle sizes, vehicle shapes, vehicle dimensions, vehicle frames, vehicle components, configurations, occlusions, sensor mounts and/or platforms, etc. In some examples, a configuration associated with a vehicle platform can include, define, represent, describe, and/or correspond to (without limitation) shape parameters of the body of the vehicle platform, height parameters of the body of the vehicle platform, one or more dimensions of the body of the vehicle platform, one or more occlusions associated with the vehicle body type of the vehicle platform and/or a cabin of the vehicle platform, lighting conditions within an interior and/or exterior of the vehicle platform, one or more lighting systems used to illuminate a scene around (and/or associated with) the vehicle platform, a model of the vehicle platform, one or more sensor mounts (and/or one or more configurations of a sensor mount(s) such as a pose relative to the vehicle platform), one or more widths, a number of passenger seats, an expected position and/or orientation of a passenger(s) of the vehicle platform relative to one or more portions of the vehicle platform and/or one or more objects inside or outside of the vehicle platform, etc.

In some examples, a vehicle configuration can additionally or alternatively include, define, represent, describe, and/or correspond to (without limitation) one or more types of sensors associated with the vehicle platform (e.g., LIDARs, RADARs, camera sensors, IMUs, acoustic sensors, time-of-flight sensors, etc.); one or more sensor configurations (e.g., focal lengths, FOVs, frame rates, apertures, sensor data processing parameters, raw data formats, etc.); one or more placements of sensors on a vehicle platform such as a sensor orientation relative to the vehicle platform and/or an associated environment, a sensor location/position relative to the vehicle platform and/or an associated environment, a sensor placement on an interior and/or exterior of the vehicle platform, a sensor placement on a roof of the vehicle platform, a sensor placement on a bumper of the vehicle platform, a sensor placement on/inside a lighting system of the vehicle platform, a sensor placement on/inside a lamp of the vehicle platform, a sensor placement on a frame of the vehicle platform, a sensor placement on a mirror(s) in an exterior of the vehicle platform (e.g., a sideview mirror, etc.) and/or an interior (e.g., a steering wheel, a seat(s), an electronic system, a dashboard, a window, a mount, a door, a front side, a back side, a left side, a right side, a top side, a bottom side, etc.) of the vehicle platform; etc.

In some aspects, one or more occlusions associated with a vehicle platform can include an object(s), a device(s), a structure(s), a condition(s)/event(s), and/or a person that is/are within a FOV of a sensor(s) and/or within an area that can be sensed, measured, and/or detected the sensor(s) but is occluded from (e.g., hidden, blocked, obstructed, etc.) the sensor(s) (and/or from a view/visibility of the sensor(s)). The one or more occlusions can be occluded from the sensor(s) by one or more occluding elements, such as a person, an object, a structure, a condition (e.g., a lighting condition, weather etc.), etc. The one or more occluding elements can hide the one or more occlusions from the sensor(s), block or impair a view/visibility of the sensor(s) to the one or more occlusions, obstruct an ability of the sensor(s) to capture sensor data corresponding to the one or more occlusions (e.g., obstruct an ability of the sensor(s) to capture measurements of the one or more occlusions, data depicting the one or more occlusions, data describing the one or more occlusions, etc.), and/or otherwise occlude the one or more occlusions from the sensor(s).

In some examples, the one or more occlusions can include, result from, and/or relate to, without limitation, an object, a device, a lighting condition, a passenger and/or a structure of the vehicle platform and/or a portion of a scene outside of the vehicle platform (e.g., an external object, pedestrian, vehicle, portion of the vehicle platform, scene agent, etc.) that is/are predicted to at least partly occlude (e.g., block, hide, obstruct, impair, and/or negatively affect a visibility to) an area within a FOV of the sensor(s) on the vehicle platform (e.g., within a FOV of a camera sensor, a LIDAR, a RADAR, an acoustic sensor, a TOF sensor, and/or any other sensor) and/or occlude something within the area. Since the area is within the FOV of the sensor(s), such area would otherwise be visible to the sensor(s) absent one or more occluding elements (e.g., such area would not be occluded or would be less occluded but for a particular position and/or orientation of the one or more occluding elements). In other words, the one or more occlusions would not be occluded by the one or more occluding elements if the one or more occluding elements were not present at one or more respective locations and/or have one or more respective orientations relative to such area.

In some cases, the one or more occlusions can include, result from, and/or relate to, without limitation, an object, a device, a lighting condition, a person, and/or a structure of/on the vehicle platform that is predicted to at least partly occlude an occlusion, such as a person(s) (e.g., a driver, a navigator, etc.) or a portion of a scene, from a sensor(s) on the vehicle platform and/or degrade a quality of sensor data (e.g., an image, video frame, measurement, point cloud, value, etc.) collected by the sensor(s) on the vehicle platform about the area within the FOV of the sensor(s) that includes the occlusion. For example, an occlusion can include something (e.g., an object, a person, a device, a structure, an event, a condition, a region, etc.) that is within an area that can be sensed, detected, imaged, and/or measurable by a sensor (e.g., that is within a FOV of the sensor) on the vehicle platform. The occlusion can be caused by one or more occluding elements, such as an object, a person, a structure, a device, and/or condition (e.g., a lighting condition) relative to the sensor(s). The occluding element can block or impair a view/visibility of the sensor(s) to the occlusion, hide the occlusion from the sensor(s), obstruct an ability of the sensor(s) to obtain sensor data corresponding to the occlusion, etc.

As previously mentioned, the simulation data (e.g., simulations 240) generated by the simulation framework 200 can be used to train/configure a model, such as a machine learning model, to map data from a first vehicle platform to a second vehicle platform and process the mapped data (or use the mapping to process the data from the first vehicle platform). In some cases, the simulation data can be used to train/configure the model to handle data from different types of vehicle platforms. For example, the simulation data from the simulation framework 200 can be used to train a perception neural network model, a control neural network model, a planning neural network model, a prediction neural network model, a localization neural network model, a tracking neural network model, and/or any other neural network model(s) to map data from a first vehicle platform to a second vehicle platform (e.g., a base or reference vehicle platform) and process the mapped data (or use the mapping to process the data from the first vehicle platform). In some cases, the simulation data can be used to train any of such models to handle data from the first vehicle platform (or from any vehicle platform) by mapping the data from the first vehicle platform to the second vehicle platform. Such model(s) can be trained and/or configured to handle data from the second vehicle platform. Thus, such model(s) can process/handle the data mapped from the first vehicle platform to the second vehicle platform or use the mapping to process/handle the data from the first vehicle platform.

To illustrate, a machine learning model can be configured to handle data (and perform certain operations) from a reference vehicle platform (e.g., from sensors on a vehicle platform including a particular size, body type, shape, height, width, dimensions, configuration, etc.), such as data captured by one or more sensors on the reference vehicle platform having a particular perspective from one or more respective poses (e.g., locations and orientations) of the sensors on the reference vehicle platform and/or depicting, describing, representing, and/or measuring a scene given a particular context of the reference vehicle platform. In some cases, to test, train, configure, and/or validate that the machine learning model can also handle data captured by one or more sensors on a different vehicle platform and/or to map data from the different vehicle platform to the reference vehicle platform, the simulation framework 200 can use simulation data to simulate one or more conditions associated with the data from the reference vehicle platform and/or simulate a performance of the machine learning model when handling the data captured by sensors from the reference vehicle platform. The simulation(s) can be applied to data from a different vehicle platform to map the data from the different vehicle platform to the reference vehicle platform and/or adjust the data from the different vehicle platform to appear and/or behave like the data from the reference vehicle platform.

The simulation data can include sensor data such as, for example and without limitation, camera sensor data (e.g., a still image(s), a video frame(s), etc.), LIDAR data, RADAR data, IMU data, a point cloud, acoustic data, etc. In some cases, the simulation data can additionally include a context and/or information about a context of the reference vehicle platform (and/or a sensor(s) used to capture associated sensor data). The context can include, for example, a particular body type of the reference vehicle platform, an environment in which the reference vehicle platform collected data used to map data from a different vehicle platform, any objects and/or vehicles in the environment, weather encountered by the reference vehicle platform when collecting the data, lightning conditions in of the reference vehicle platform and/or the associated environment, traffic conditions in the environment at the time when the data was collected by the reference vehicle platform, road conditions in the environment when the data was collected by the reference vehicle platform, visibility conditions encountered by the reference vehicle platform when collecting the data, kinematics of one or more road agents, scene elements, data features, and/or any information about the data, the sensors, the reference vehicle platform, the environment, and/or the context.

In this example, the simulation framework 200 can generate simulation data that the systems and techniques described herein can use to simulate the context of the reference vehicle platform. The simulation data can by a model when mapping data from a different vehicle platform to the reference vehicle platform to ensure the data from the different vehicle platform contains and/or captures the context associated with the reference vehicle platform. This way, when mapping data from a different vehicle platform to a reference vehicle platform, the context associated with such data is the same/matches.

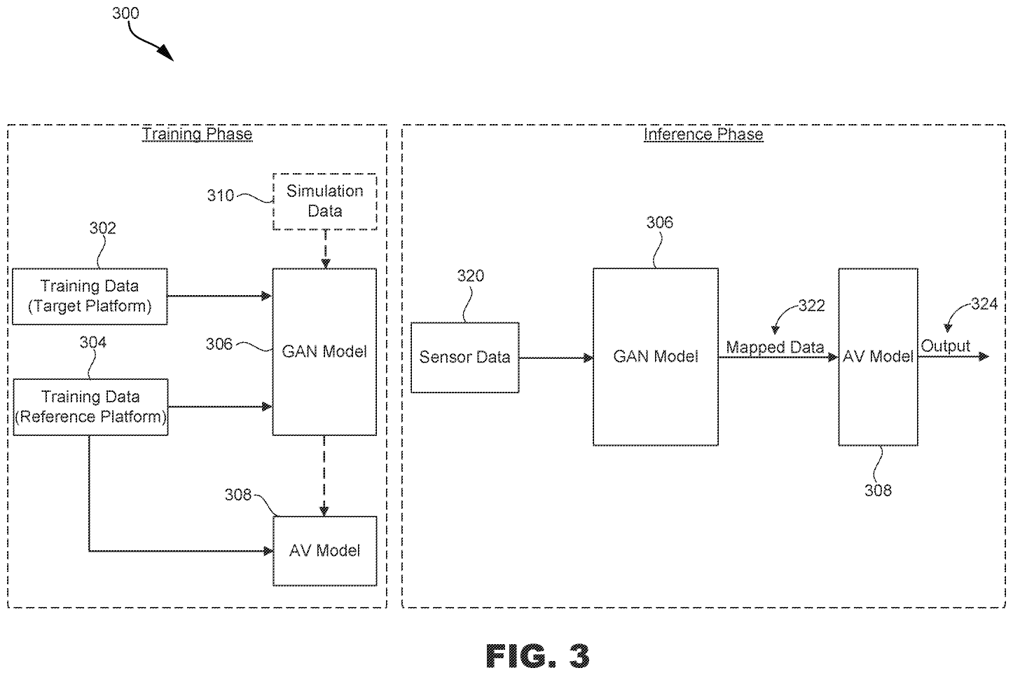

FIG. 3 is a diagram illustrating an example system 300 for processing data from different vehicle platforms. In this example, the system 300 can include a training phase used to train a generative adversarial network (GAN) 306 to map data from a target vehicle platform to a reference vehicle platform and train an AV model 308 to process data from the reference vehicle platform. The system 300 in this example also includes an inference phase used to process data from the target vehicle platform once the GAN model 306 and the AV model 308 are trained.

In the training phase, the GAN model 306 can receive target training data 302 corresponding to a target vehicle platform and reference training data 304 corresponding to a reference vehicle platform. For clarity and explanation purposes, the training data 302 will be referenced hereinafter as “the target training data 302” to indicate that the training data 302 corresponds to the target vehicle platform, and the training data 304 will be referenced hereinafter as “the reference training data 304” to indicate that the training data 304 corresponds to the reference vehicle platform. In some cases, the GAN model 306 can additionally receive simulation data 310 generated by a simulation framework, such as simulation framework 200 shown in FIG. 2.

The target training data 302 can include sensor data captured by one or more sensors on the target vehicle platform. For example, the target training data 302 can include sensor data captured by one or more sensors on the target vehicle platform having one or more poses (e.g., locations and orientations) relative to the target vehicle platform, one or more FOVs, one or more occlusions associated with the target vehicle platform and/or respective poses of the one or more sensors relative to the target vehicle platform, and/or one or more perspectives associated with the target vehicle platform and/or the respective poses of the one or more sensors on the target vehicle platform. In some examples, one or more aspects of the target training data 302 can depend on and/or be affected by one or more aspects of the target vehicle platform as further described herein. For example, one or more aspects of the target training data 302 can depend on and/or be affected by a body type of the target vehicle platform, a size of the target vehicle platform, a shape of the target vehicle platform, a configuration of the target vehicle platform, a dimension(s) of the target vehicle platform, a number and/or type of sensors on the target vehicle platform, a pose (e.g., location and orientation) of the sensors on the target vehicle platform, etc.

Similarly, the reference training data 304 can include sensor data captured by one or more sensors on the reference vehicle platform. For example, the reference training data 304 can include sensor data captured by one or more sensors on the reference vehicle platform having one or more poses (e.g., locations and orientations) relative to the reference vehicle platform, one or more FOVs, one or more occlusions associated with the reference vehicle platform and/or respective poses of the one or more sensors relative to the reference vehicle platform, and/or one or more perspectives associated with the reference vehicle platform and/or the respective poses of the one or more sensors on the reference vehicle platform. In some examples, one or more aspects of the reference training data 304 can depend on and/or be affected by one or more aspects of the reference vehicle platform as further described herein. For example, one or more aspects of the reference training data 304 can depend on and/or be affected by a body type of the reference vehicle platform, a size of the reference vehicle platform, a shape of the reference vehicle platform, a configuration of the reference vehicle platform, a dimension(s) of the reference vehicle platform, a number and/or type of sensors on the reference vehicle platform, a pose (e.g., location and orientation) of the sensors on the reference vehicle platform, etc.

The simulation data 310 can include a simulated context of the target training data 302, a simulated context of the reference training data 304, one or more contextual attributes of the target training data 302, and/or one or more contextual attributes of the reference training data 304. For example, the simulation data 310 can include a simulation of a scene/environment in which the target training data 302 was collected and/or a simulation of a scene/environment in which the reference training data 304 was collected. In some cases, the simulation data 310 can include a scene in which the target training data 302 and/or the reference training data 304 was/were collected, a scene condition (e.g., weather conditions, lighting conditions, traffic conditions, etc.) of the target training data 302 and/or the reference training data 304, kinematics of one or more agents in a scene associated with the target training data 302 and/or the reference training data 304, a vehicle platform context (e.g., a speed, an orientation, a direction or trajectory, an operation, a maneuver, a vehicle platform body type, a vehicle platform size, a vehicle platform shape, a vehicle platform dimension(s), a vehicle platform configuration, etc.) of the target vehicle platform and/or the reference vehicle platform, activity in a scene in which the target training data 302 and/or the reference training data 304 was/were captured, and/or any other context information.

In some examples, the GAN model 306 can include a form of generative neural network that can learn patterns in input data (e.g., target training data 302, reference training data 304) so that the neural network model can generate new synthetic outputs that reasonably could have been from the original dataset. In some cases, the GAN model 306 can include two neural networks that operate together. One of the neural networks (referred to as a generative neural network or generator) generates a synthesized output, and the other neural network (referred to as a discriminative neural network or discriminator) evaluates the output from the generative neural network (or generator) for authenticity (e.g., to determine whether the output appears to be from an original dataset, such as the training dataset 304 and/or matches/mirrors data from the original dataset) or whether the output is generated by the generative neural network (or generator). In other words, the generative neural network (or generator) can generate data intended to match, mirror, and/or appear as real data from the reference vehicle platform, and the discriminative neural network (or discriminator) can evaluate the data generated by the generative neural network (or generator) to determine if such data can pass as real data from the reference vehicle platform (e.g., to determine whether the discriminative neural network can detect whether the data was generated by the generative neural network or whether the data was collected by sensors on the reference vehicle platform).

In some examples, the training input and output of the GAN model 306 can include sensor data from different vehicle platforms (e.g., target training data 302 and reference training data 304), such as sensor data from the target vehicle platform and sensor data from the reference vehicle platform. The generator can be trained to try to fool the discriminator into determining that synthesized data generated by the generator is real data from the dataset. The training process continues and the generator becomes better at generating the synthetic data that appears like real data. The discriminator continues to find flaws in the synthesized data, and the generator figures out what the discriminator is looking at to determine the flaws in the data. Once the network is trained, the generator can produce realistic data that the discriminator is unable to distinguish from the real data. For example, once the network is trained, the generator can use data from the target vehicle platform to produce realistic sensor data that appears to be from the reference vehicle platform, whereas such output data is so realistic such that the discriminator is unable to distinguish between that data and other sensor data from the reference vehicle platform.

The GAN model 306 is provided as an illustrative network provided for explanation purposes. In other examples, the system 300 can implement other types of networks. For example, in other cases, the system 300 can implement other models for object-oriented data (de)composition such as, for example, frameworks based on deep variational auto-encoders (VAEs). In some cases, the data (e.g., scene) generation of the GAN model 306 can be based on ConvNets or a Neural Radiance Fields (NeRFs) module, which can render a scene by decoding a structured latent variable. The discriminator model can learn to distinguish the real scene data from the fake samples that are produced by the ConvNets or NeRFs as the generator model. Multiple models can be trained as, in some examples, the models can play a minimax game.

In some examples, the GAN model 306 can use the simulation data 310 to apply a context (or one or more contextual attributes) of the reference training data 304 to the target training data 302. Moreover, the GAN model 306 can use the target training data 302 and the reference training data 304 to map the target training data 302 to the reference training data 304. In some examples, the GAN model 306 can generate a version of the reference training data 304 (e.g., a version of data from the target vehicle platform) that appears like, mirrors, and/or matches the reference training data 304 (e.g., that appears like, mirrors, and/or matches data from the reference vehicle platform). For example, the GAN model 306 can use the simulation data 310, the target training data 302, and the reference training data 304 to generate a version of the target training data 302 that matches or mirrors a perspective of the reference training data 304, that includes a context of the reference training data 304, that includes one or more occlusions from the reference training data 304 (e.g., which are not included in the target training data 302), that excludes one or more occlusions from the target training data 302 (e.g., that are not included in the reference training data 304), and/or that measures or depicts a portion of a scene within a FOV of one or more sensors used to capture the target training data 302.

In some cases, if the target training data 302 includes an occluding element that occludes an element (e.g., an object, a person, a structure, etc.) in a scene associated with the target training data 302 that is not occluded in the reference training data 304, the GAN model 306 can adjust the target training data 302 to depict the element in the reference training data 304 that is occluded in the target training data 302. For example, the GAN model 306 can generate the element and place the element within the target training data 302 at a location of the element found in the reference training data 304 (e.g., where the occluding element that occludes the element is located). Similarly, if the reference training data 304 includes an occluding element that occludes an element (e.g., an object, a person, a structure, etc.) in the reference training data 304 that is not occluded in the target training data 302, the GAN model 306 can adjust the target training data 302 to occlude the element in the target training data 302 so the element is occluded in the target training data 302 as it is in the reference training data 304.

In some examples, the GAN model 306 can modify the target training data 302 to at least partly include a same context as the reference training data 304. For example, the GAN model 306 can modify the target training data 302 to include match or mirror a context of the reference training data 304, a scene condition (e.g., weather conditions, lighting conditions, traffic conditions, etc.) of the reference training data 304, kinematics of one or more agents in a scene associated with the reference training data 304, a vehicle platform context (e.g., to adjust a state of the target vehicle platform to match or mirror a state of the reference vehicle platform such as a speed, an orientation, a direction or trajectory, an operation, a maneuver, etc.), scene activity, and/or any other context information. In some cases, the GAN model 306 can use the simulation data 310 to modify the target training data 302 to match or mirror at least a portion of a context of the reference training data 304. For example, the GAN model 306 can use the simulation data 310, which can include a context of the reference training data 304 (and/or contextual attributes thereof), to obtain the context (and/or contextual attributes) of the reference training data 304 and apply it to the target training data 302.

As previously explained, in some examples, the simulation data 310 can provide a simulation of one or more aspects of a context of the reference training data 304. For example, the simulation data 310 can provide a simulation of a context associated with the reference training data 304. In some cases, the GAN model 306 can adjust the target training data 302 to reflect a context of the reference training data 304 based on the simulation data 310. For example, the GAN model 306 can adjust the target training data 302 based on simulation data 310, which can simulate a context of the reference training data 304, so that the target training data 302 reflects a same context as the reference training data 304.

In some cases, the GAN model 306 can map sensor data in the target training data 302 to a same type of sensor data in the reference training data 304. For example, the GAN model 306 can map LIDAR data that has a perspective and/or context of the target training data 302 to a version of the LIDAR data that has a perspective and/or context of the reference training data 304, RADAR data that has a perspective and/or context of the target training data 302 to a version of the RADAR data that has a perspective and/or context of the reference training data 304, camera data that has a perspective and/or context of the target training data 302 to a version of the camera data that has a perspective and/or context of the reference training data 304, TOF sensor data that has a perspective and/or context of the target training data 302 to a version of the TOF sensor data that has a perspective and/or context of the reference training data 304, or acoustic data that has a perspective and/or context of the target training data 302 to a version of the acoustic data that has a perspective and/or context of the reference training data 304. As another example, the GAN model 306 can map a specific type of sensor data (e.g., LIDAR data, RADAR data, camera data, acoustic data, TOF sensor data, etc.) that has a perspective and/or context of the target training data 302 to fused data from a combination of sensors (e.g., one or more LIDARs, RADARs, camera sensors, acoustic sensors, and/or TOF sensors) that have a perspective and/or context of the reference training data 304.

In other cases, the GAN model 306 can map sensor data from the target training data 302 to different type of sensor data from the reference training data 304. For example, the GAN model 306 can map LIDAR data in the target training data 302 to RADAR or camera data that has a perspective and/or context of the reference training data 304, or vice versa. As another example, the GAN model 306 can map particular sensor data from the target training data 302 to fused sensor data from a combination of sensors (e.g., one or more LIDARs, RADARs, camera sensors, TOF sensors, acoustic sensors, etc.) that have a perspective and/or context of the reference training data 304, or vice versa.

The AV model 308 can include any software and/or software stack, algorithm, machine learning model, and/or component implemented by a vehicle, such as AV 102. For example, the AV model 308 can include a perception stack (e.g., perception stack 112), a localization stack (e.g., localization stack 114), a prediction stack (e.g., prediction stack 116), a planning stack (e.g., planning stack 118), a communications stack (e.g., communications stack 120), and/or a control stack (e.g., control stack 122) of the AV 102. In some examples, the AV model 308 can receive data, such as sensor data, and use the data to perform perception operations (e.g., object detection, object recognition, scene recognition, classification, semantic object detection and/or recognition, event detection, etc.), localization and tracking operations (e.g., vehicle localization, agent localization, vehicle tracking, agent tracking, etc.), prediction operations (e.g., route prediction, behavior or activity prediction, state prediction, event prediction, yield/assert predictions, pedestrian behavior predictions, vehicle predictions, etc.), planning operations (e.g., yield/assert planning, routing planning, behavior planning, etc.), and/or other operations.

In the training phase, the system 300 can train the AV model 308 to process data from the reference vehicle platform. For example, the system 300 can train the AV model 308 to process and handle the reference training data 304 associated with the reference vehicle platform. In some examples, the system 300 can use reference training data (e.g., the reference training data 304 or a portion thereof) to train the AV model 308 to process a format of data from the reference vehicle platform and/or process data captured from a FOV of one or more sensors on the reference vehicle platform, data having one or more occlusions found in sensor data in the reference vehicle platform, data including one or more portions of a scene sensed (e.g., measured, depicted, represented, etc.) by sensor data from the reference vehicle platform, data reflecting one or more perspectives of sensor data from the reference vehicle platform, data including a context of sensor data from the reference vehicle platform, data reflecting a view of one or more sensors on the reference vehicle platform, and/or data that includes any other attributes of sensor data from the reference vehicle platform.

To illustrate, assume that data from a camera sensor on the reference vehicle platform reflects a FOV of that camera sensor given a pose (e.g., location and orientation) of that camera sensor on the reference vehicle platform. Given the FOV of that camera sensor, the data may depict certain portions of a scene relative to the reference vehicle platform and may reflect certain conditions based on the pose of the camera sensor such as, for example, a lighting condition of the scene depicted in the data from the camera sensor, one or more occlusions caused by one or more objects within the FOV of the camera sensor, etc. In some cases, the body type of the reference vehicle platform may also affect what portions (if any) of the vehicle platform (e.g., of the exterior and/or interior) are depicted in the data from the camera sensor, what obstructions (if any) on the view of the camera sensor are encountered by the camera sensor (and reflected in the data), and/or other attributes of the data from the camera sensor on the reference vehicle platform. In this example, the system 300 can use the reference training data 304 to train the AV model 308 to process data reflecting the FOV of the camera sensor, data depicting the certain portions of the scene relative to the reference vehicle platform, data reflecting any conditions reflected in the data from the reference vehicle platform, data depicting portions (if any) of the reference vehicle platform depicted in data from the reference vehicle platform, data reflecting obstructions (if any) encountered by data from the reference vehicle platform, etc.

In the inference phase, the system 300 can use the GAN model 306 and the AV model 308 to process data from the target vehicle platform as if such data was instead collected by sensors on the reference vehicle platform. For example, the system 300 can collect sensor data 320 from the target vehicle platform. The sensor data 320 can include data captured by one or more sensors of the target vehicle platform, such as scene data, a measurement, an image, a video frame, a point cloud, etc. In some examples, the sensor data 320 can include and/or reflect one or more characteristics defined by, affected by, and/or associated with the target vehicle platform. For example, the sensor data 320 can include data from a perspective of sensors on the target vehicle platform given their pose relative to the target vehicle platform. As another example, the sensor data 320 can additionally or alternatively include a portion of a scene defined at least in part by the pose of the sensors on the target vehicle platform and attributes of the target vehicle platform (e.g., a size of the target vehicle platform, dimensions of the target vehicle platform, a shape of the target vehicle platform, a body type of the target vehicle platform, a type and/or number of sensors on the target vehicle platform, a placement of sensors on the target vehicle platform, etc.), one or more occlusions in the data that are based on the target vehicle platform and/or the pose of the sensors on the target vehicle platform, a context of the target vehicle platform, etc. As another example, the sensor data 320 can additionally or alternatively reflect a specific view/visibility of sensors on the target vehicle platform.

The GAN model 306 can map the sensor data 320 from the target vehicle platform to the reference vehicle platform. For example, the GAN model 306 can map the sensor data 320 from the target vehicle platform to the reference vehicle platform to generate mapped data 322. In some cases, to generate the mapped data 322, the GAN model 306 can modify the sensor data 320 to appear as if the sensor data was collected from the reference vehicle platform. In some aspects, to generate the mapped data 322, the GAN model 306 can transfer one or more elements and/or attributes associated with the reference vehicle platform (e.g., one or more elements and/or attributes in data from the reference vehicle platform) to the sensor data 320. For example, the GAN model 306 can transfer an occlusion in data associated with the reference vehicle platform to the sensor data 320 such that the occlusion is reflected in the mapped data 322. As another example, the GAN model 306 can transfer to the sensor data 320 an element in sensor data associated with the reference vehicle platform that is otherwise occluded in the sensor data 320 such that the element is reflected in the mapped data 322 despite such element being occluded in the sensor data 320. As yet another example, the GAN model 306 can transfer to the sensor data 320 a perspective of data associated with the reference vehicle platform such that the mapped data 322 appear to have the perspective associated with the reference vehicle platform even if the sensor data 320 used to generate the mapped data 322 had a different perspective.

In some examples, the mapped data 322 can include a version of the sensor data 320 that includes and/or reflects a perspective of the reference vehicle platform (e.g., a perspective of the sensors used to collect the sensor data 320 if such sensors were implemented by the reference vehicle platform), a perspective of the sensors used to collect the sensor data 320 given a pose of the sensors on and/or relative to the reference vehicle platform, etc. As another example, the mapped data 322 can additionally or alternatively include a portion of a scene defined at least in part by a pose of sensors on the reference vehicle platform and/or attributes of the reference vehicle platform (e.g., a size of the reference vehicle platform, dimensions of the reference vehicle platform, a shape of the reference vehicle platform, a body type of the reference vehicle platform, a type and/or number of sensors on the reference vehicle platform, a placement of sensors on the reference vehicle platform, etc.).

In some cases, the mapped data 322 can additionally or alternatively include one or more occlusions that were not originally included in the sensor data 320 but would otherwise be included in sensor data from the reference vehicle platform, exclude one or more occlusions originally included in the sensor data 320 that would not be otherwise included in sensor data from the reference vehicle platform, include a portion of sensor data determined based on one or more characteristics of the reference vehicle platform (e.g., the body type, size, shape, dimensions, configuration, and/or other attributes of the reference vehicle platform) and/or the pose of sensors on the reference vehicle platform, reflect a pose (e.g., location and orientation) of one or more elements (e.g., objects, structures, lighting systems, obstructions, etc.) of/on the reference vehicle platform (e.g., an interior and/or an exterior thereof), include and/or reflect one or more conditions associated with the reference vehicle platform (e.g., lighting conditions, light reflectivity, opacity of one or more objects and/or structures, one or more obstructions of a view of one or more sensors on the reference vehicle platform, etc.), reflect a specific view/visibility of sensors on the reference vehicle platform, etc.

The GAN model 306 can provide the mapped data 322 to the AV model 308, which can process the mapped data 322 to generate an output 324. As previously explained, the mapped data 322 can include the sensor data 320 modified to appear as if the sensor data 322 was captured from the reference vehicle platform, modified to mirror data and/or aspects of data from the reference vehicle platform, and/or modified to match one or more aspects and/or characteristics of data from the reference vehicle platform. Moreover, the AV model 308 can be trained and configured to process data from the reference vehicle platform. However, since the mapped data 322 appears, mirrors, and/or matches data, aspects of data, and/or characteristics of data from the reference vehicle platform, the AV model 308 can process the mapped data 322 to generate the output 324 as it otherwise processes data from the reference vehicle platform (e.g., as if the mapped data 322 were collected from the reference vehicle platform). In this way, the system 300 does not need to implement different AV models for different vehicle platforms, and the AV model 308 can process data from the target vehicle platform (and any other vehicle platforms) in addition to data from the reference vehicle platform, without having to retrain the AV model 308, which was previously trained for the reference vehicle platform, to process data from the target vehicle platform.

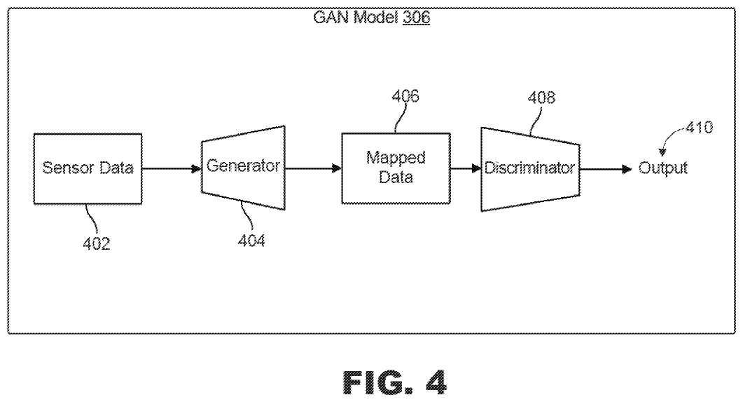

FIG. 4 illustrates an example of the GAN model 306 used to map data from a target vehicle platform to a reference vehicle platform. In this example, the GAN model 306 includes a generator 404 and a discriminator 408. The generator 404 can receive sensor data 402 collected from a target vehicle platform, and map the sensor data 402 from the target vehicle platform to a reference vehicle platform (and/or from a domain of the target vehicle platform to a domain of the reference vehicle platform). The generator 404 can generate the mapped data 406 based on the mapping of the sensor data from the target vehicle platform to the reference vehicle platform. In some examples, the generator 404 can transfer one or more attributes of data from the reference vehicle platform to the sensor data 402 from the target vehicle platform. In some cases, the generator 404 can additionally or alternatively modify the sensor data 402 to implement one or more characteristics of data from the reference vehicle platform and/or to exclude one or more characteristics of the sensor data 402 that are not included in data from the reference vehicle platform.

In some examples, to generate the mapped data 406, the generator 404 can generate synthetic data based on the sensor data 402 and a mapping for the sensor data 402 to the reference vehicle platform. For example, if the sensor data 402 includes an image captured from a perspective corresponding to the target vehicle platform, the generator 406 can use the sensor data 402 to generate a synthetic image that includes the sensor data 402 modified to appear as if the sensor data 402 was collected from the reference vehicle platform. In some implementations, a last layer of the generator 404 can use a hyperbolic tangent (tanh) function as an activation function to ensure that the intensity values of the synthetic image generated by the generator 404 is normalized between 0 and 1.

In some examples, the mapped data 406 can include the sensor data 402 modified to include one or more characteristics and/or attributes of data of a sample dataset corresponding to the reference vehicle platform. In some cases, the one or more characteristics and/or attributes of the data of the sample dataset can include, for example and without limitation, one or more occlusions, one or more perspectives, one or more portions of a scene otherwise occluded in the sensor data 402, data from a FOV of one or more sensors on the reference vehicle platform, a lighting condition, a visibility parameter, an opacity parameter, and/or one or more features.

The generator 404 can send the mapped data 406 to the discriminator 408. The discriminator 408 can be configured to recognize data from the reference vehicle platform and/or determine whether data from the generator 404 corresponds to the reference vehicle platform or not. In some cases, the discriminator 408 can be configured to determine whether the mapped data 406 was generated by the generator 404 and/or includes synthetic data generated by the generator 404, or whether the mapped data 406 includes real sensor data and/or real sensor collected from the reference vehicle platform. In some cases, the goal of the generator 404 can include to fool or trick the discriminator 408 into recognizing the mapped data 406 generated by the generator 404 as authentic (e.g., as real sensor data and/or real sensor data collected from the reference vehicle platform), and the goal of the discriminator 408 can include to recognize the mapped data generated by the generator 404 as fake. In some cases, the goal of the generator 404 can include to generate realistic data with specific one or more characteristics and/or attributes corresponding to and/or transferred from data collected from the reference vehicle platform, and the goal of the discriminator 408 can include to recognize the one or more characteristics and/or attributes.

The discriminator 408 can be used to distinguish between synthetic data generated by the generator 404 and real sensor data sampled from a dataset of data collected from the reference vehicle platform, and/or to distinguish between data corresponding to the reference vehicle platform and data corresponding to other vehicle platforms. The discriminator 408 can generate a discrimination output 410 which can specify whether the mapped data 406 is believed to be real sensor data and/or real sensor data collected from the reference vehicle platform.

In some cases, when processing the mapped data 406, the discriminator 408 can extract features from the mapped data 406 and analyze the extracted features to attempt to distinguish the mapped data 406 from sample data collected from the reference vehicle platform.

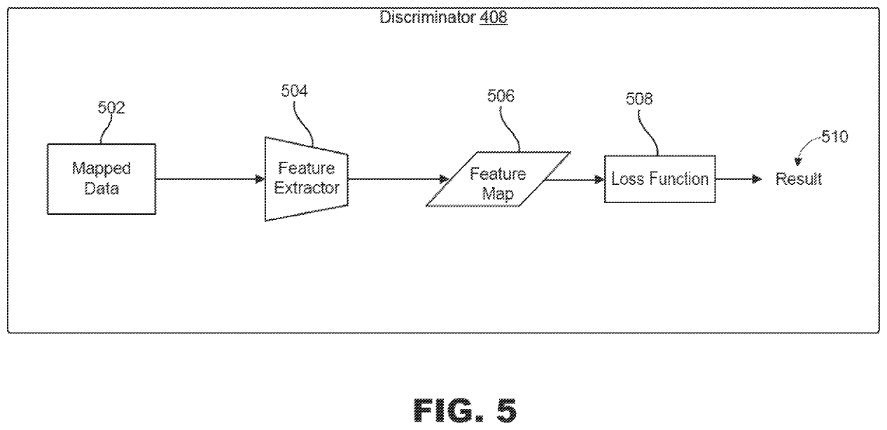

FIG. 5 is a diagram of an example configuration of the discriminator 408 implemented in a GAN model to distinguish data from a generator.

In this example, the discriminator 408 can receive mapped data 502 from a generator, such as generator 404. The mapped data 502 can be fed into a feature extractor 504, which can analyze the mapped data 502 to extract features in the mapped data 502. The feature extractor 504 can then output a feature map 506 associated with the mapped data 502. The feature map 506 can be fed to a loss function 508 implemented by the discriminator 408.

The discriminator 408 can apply the loss function 508 to the feature map 506 from the feature extractor 504. In some examples, the loss function 508 can include a least squares loss function. The loss function 508 can output a result 510. In some examples, the result 510 can be a binary or probabilities output such as [true, false] or [0, 1]. Such output (e.g., result 510) can, in some cases, provide a classification or discrimination decision. For example, in some cases, the output (result 510) can recognize or classify the mapped data 502 as including real data collected by sensors from the reference vehicle platform or including synthetic data generated by a generator (e.g., generator 404).

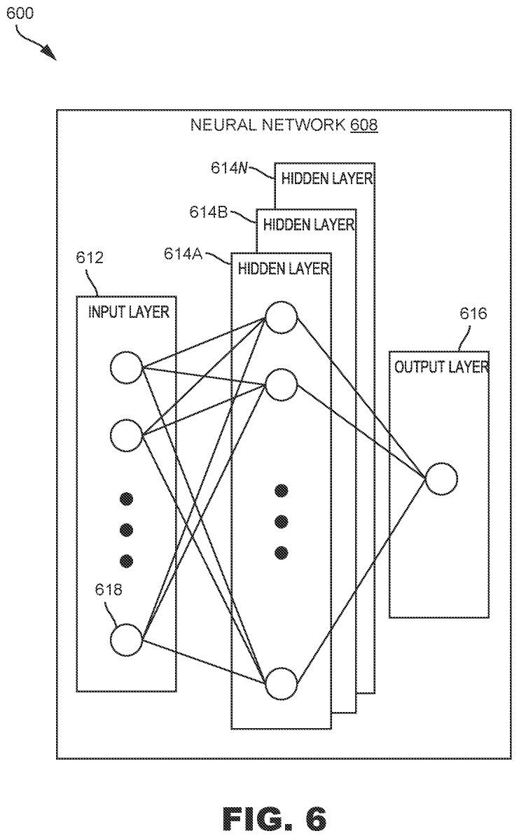

FIG. 6 illustrates an example configuration 600 of a neural network 608 that can be implemented by a model such as the GAN model 306, the AV model 308, the generator 404, and/or the discriminator 408. The example configuration 600 is merely one illustrative example provided for clarity and explanation purposes. One of ordinary skill in the art will recognize that other configurations of a neural network are also possible and contemplated herein.

In this example, the neural network 608 includes an input layer 612 which includes input data. The input data can include sensor data such as, for example, image data (e.g., video frames, still images, etc.) from one or more image sensors, LIDAR data from one or more LIDARs, RADAR data from one or more RADARs, acoustic data from one or more acoustic sensors, and/or any other type of sensor data. For example, the input data can include sensor data 320 previously described with respect to FIG. 3. The input data can capture, measure, and/or depict a view, scene, environment, shape, condition, scene element, and/or object. For example, the input data can depict a scene associated with an AV, such as the AV 102 shown in FIG. 1. In one illustrative example, the input layer 612 can include data representing the pixels of one or more input images depicting an environment of the AV 102. In other examples, the input layer 612 can include other sensor data such as, for example, LIDAR data, ultrasonic sensor data, IMU data, RADAR data, and/or any other type of sensor data.

The neural network 608 includes hidden layers 614A through 614N (collectively “614” hereinafter). The hidden layers 614 can include n number of hidden layers, where n is an integer greater than or equal to one. The number of hidden layers can be made to include as many layers as needed for a given application. The neural network 608 further includes an output layer 616 that provides an output resulting from the processing performed by the hidden layers 614. In one illustrative example, the output layer 616 can provide a classification and/or localization of one or more objects in an input, such as an input of sensor data. The classification can include a class identifying the type of object or scene (e.g., a car, a pedestrian, an animal, a train, an object, or any other object or scene), a decision, a prediction, etc. In some cases, a localization can include a bounding box indicating the location of an object or scene.

The neural network 608 can include a multi-layer deep learning network of interconnected nodes. Each node can represent a piece of information. Information associated with the nodes is shared among the different layers. In some examples, each layer can retain information as information is processed. In some cases, the neural network 608 can include a feedforward network, in which case there are no feedback connections where outputs of the network are fed back into itself. For example, the neural network 608 can implement a backpropagation algorithm for training the feedforward neural network. In some cases, the neural network 608 can include a recurrent neural network, which can have loops that allow information to be carried across nodes while reading in input.

Information can be exchanged between nodes through node-to-node interconnections between the various layers. Nodes of the input layer 612 can activate a set of nodes in the first hidden layer 614A. For example, as shown, each of the input nodes of the input layer 612 is connected to each of the nodes of the first hidden layer 614A. The nodes of the hidden layer 614A can transform the information of each input node by applying activation functions to the information. The information derived from the transformation can be passed to and can activate the nodes of the next hidden layer (e.g., 614B), which can perform their own designated functions. Example functions include convolutional, up-sampling, data transformation, pooling, and/or any other suitable functions. The output of the hidden layer (e.g., 614B) can activate nodes of the next hidden layer (e.g., 614N), and so on. The output of the last hidden layer can activate one or more nodes of the output layer 616, at which point an output is provided. In some cases, while nodes (e.g., node 618) in the neural network 608 are shown as having multiple output lines, a node has a single output and all lines shown as being output from a node represent the same output value.

In some cases, each node or interconnection between nodes can have a weight that is a set of parameters derived from training the neural network 608. For example, an interconnection between nodes can represent a piece of information learned about the interconnected nodes. The interconnection can have a numeric weight that can be tuned (e.g., based on a training dataset), allowing the neural network 608 to be adaptive to inputs and able to learn as more data is processed.

The neural network 608 can be pre-trained to process features from the data in the input layer 612 using the different hidden layers 614 in order to provide the output through the output layer 616. In an example in which the neural network 608 is used to identify objects or features in images, the neural network 608 can be trained using training data that includes images and/or labels. For instance, training images can be input into the neural network 608, with each training image having a label indicating the classes of the one or more objects or features in each image (e.g., indicating to the network what the objects are and what features they have).

In some cases, the neural network 608 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 608 is trained enough so that the weights of the layers are accurately tuned.

For the example of identifying objects in images, the forward pass can include passing a training image through the neural network 608. The weights can be initially randomized before the neural network 608 is trained. The image can include, for example, an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

For a first training iteration for the neural network 608, the output can include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 608 is unable to determine low level features and thus cannot make an accurate determination of what the classification of the object might be. A loss function can be used to analyze errors in the output. Any suitable loss function definition can be used.

The loss (or error) can be high for the first training images since the actual values will be different than the predicted output. The goal of training is to minimize the amount of loss so that the predicted output is the same as the training label. The neural network 608 can perform a backward pass by determining which inputs (weights) most contributed to the loss of the network, and can adjust the weights so that the loss decreases and is eventually minimized.

A derivative of the loss with respect to the weights can be computed to determine the weights that contributed most to the loss of the network. After the derivative is computed, a weight update can be performed by updating the weights of the filters. For example, the weights can be updated so that they change in the opposite direction of the gradient. A learning rate can be set to any suitable value, with a high learning rate including larger weight updates and a lower value indicating smaller weight updates.

The neural network 608 can include any suitable deep network. For example, the neural network 608 can include an artificial neural network, a convolutional neural network (CNN), a GAN, a generator, a discriminator, etc. In some examples, a CNN can include an input layer, one or more hidden layers, and an output layer, as previously described. The hidden layers of a CNN can include a series of convolutional, nonlinear, pooling (e.g., for down sampling), and fully connected layers. In other examples, the neural network 608 can represent any other deep network other than an artificial neural network or CNN, such as an autoencoder, a deep belief nets (DBNs), a Recurrent Neural Networks (RNNs), etc.

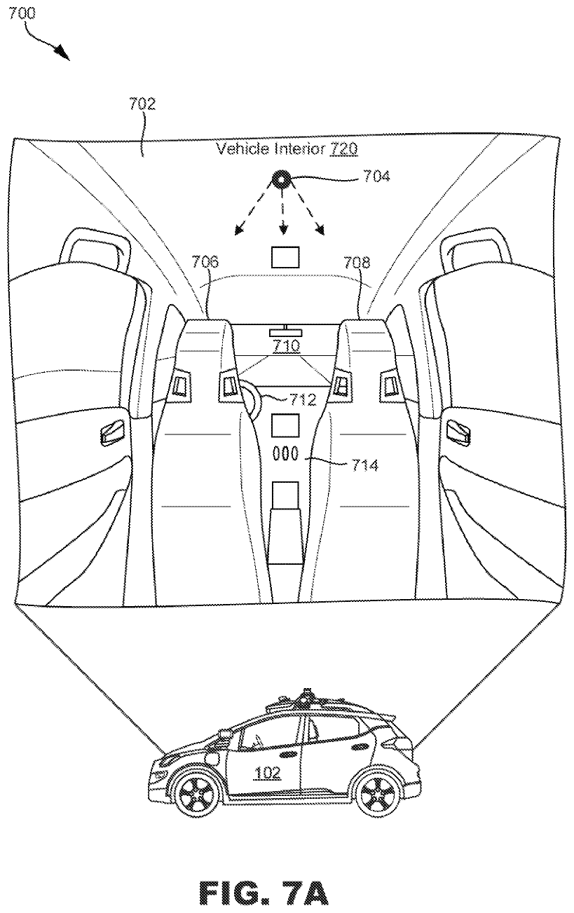

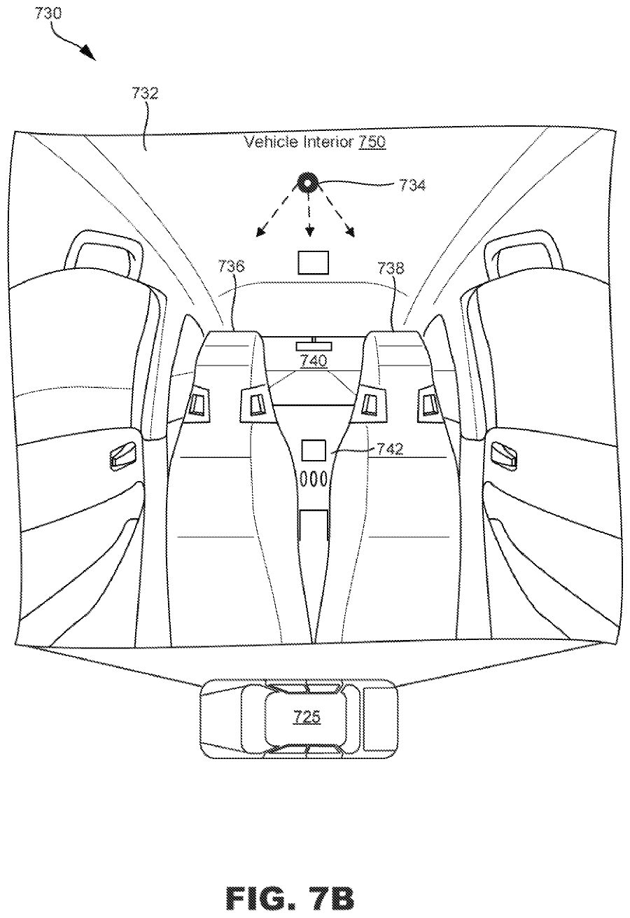

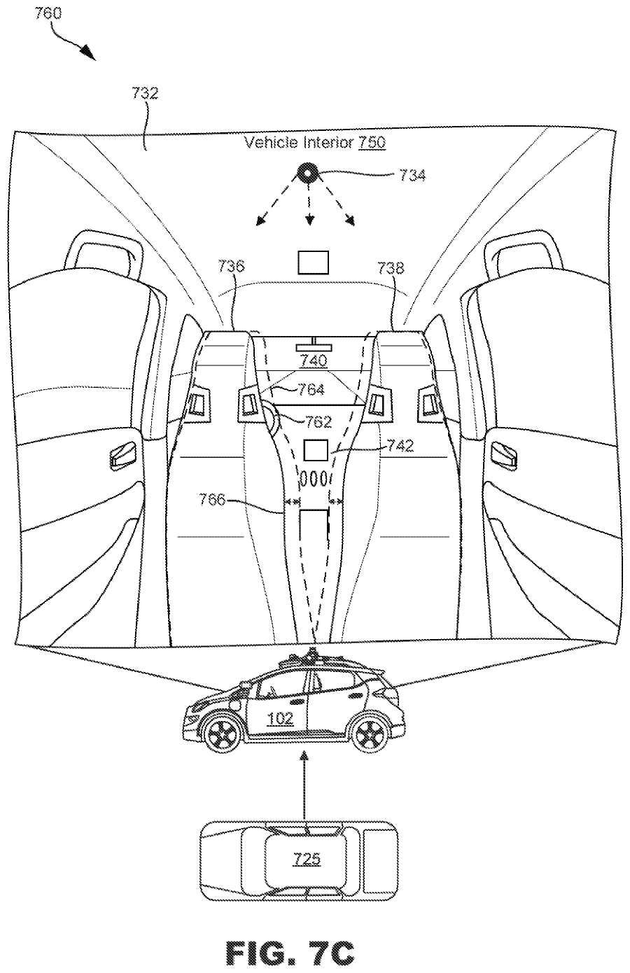

As previously explained, the systems and techniques described herein can be used to map data (e.g., sensor data) from one or more vehicle platforms to a different vehicle platform, such as a reference vehicle platform. FIGS. 7A-7B are diagrams illustrating example images of an interior (e.g., a cabin) of different vehicle platforms and FIG. 7C illustrates an example of an image of an interior of a vehicle platform mapped to a reference vehicle platform. The image data captured for the different vehicle platforms in FIGS. 7A-C and the mapping of the image data from a vehicle platform to a reference vehicle platform are further discussed below with respect to FIGS. 7A-7C.

Turning to FIG. 7A, which is a diagram illustrating an example image 700 of an interior 720 of a vehicle platform associated with AV 102, the vehicle platform associated with the AV 102 can be a target vehicle platform or a reference vehicle platform. However, in the following examples described below with respect to FIGS. 7A-7C, the vehicle platform associated with the AV 102 will be described as a reference vehicle platform.

The image 700 was collected by a camera sensor 704 on the reference vehicle platform (e.g., on AV 102). Thus, the image 700 is from the reference vehicle platform. The reference vehicle platform can describe, represent, and/or refer to the body type of the AV 102, the size of the AV 102, the shape of the AV 102, the dimensions of the AV 102, the configuration of the AV 102 (e.g., number and/or type of sensors, placement and/or pose of sensors, configuration of the interior 702 of the AV 102, the number and/or location of seats in the AV 102, the shape of the seats in the AV 102, etc.).

The image 700 can include a still image or a video frame of a video that includes sequence of video frames. The images illustrated in FIGS. 7A-7C are merely illustrative examples of sensor data from different vehicle platforms and are provided for explanation purposes. It should be noted that, in other examples, the sensor data can include other type of sensor data such as, for example and without limitation, LIDAR data, RADAR data, acoustic data, TOF data, and/or any other data. Thus, while FIGS. 7A-7C illustrate images captured by camera sensors, the systems and techniques described herein are not limited to images and camera sensors and can be implemented in the context of other types of sensors (e.g., LIDARs, RADARs, acoustic sensors such as ultrasonic sensors, etc.) and sensor data (e.g., in addition to or in lieu of an image captured by a camera sensor).

An AV model (e.g., AV model 308) implemented by the AV 102 and other vehicles, such as AV 725 illustrated in FIG. 7B, can be trained and configured to process/handle the image 700 (e.g., and other images) from the reference vehicle platform associated with the AV 102. When implementing the AV model in other vehicles, such as AV 725 illustrated in FIG. 7B, the image 730 from the target vehicle platform associated with AV 725 in FIG. 7B can be mapped to the reference vehicle platform associated with the AV 102 (e.g., to the image 700 collected from the reference vehicle platform associated with the AV 102, to a sample(s) from a training dataset corresponding to the reference vehicle platform, etc.) to enable the AV model to process and handle such data, as illustrated in FIG. 7C and further described below.

As previously noted, in this example, the image 700 can include image data captured by the camera sensor 704 on the interior 720 of the reference vehicle platform. The interior 720 of the reference vehicle platform (e.g., of the AV 702) can include, for example, an interior of a cabin (e.g., cabin system 138) of the AV 102 associated with the reference vehicle platform. The image 700 can depict at least a portion of the interior 720 of the reference vehicle platform, such as a scene in the interior 720 (e.g., inside of the cabin). In this example shown in FIG. 7A, the interior 720 of the reference vehicle platform can include a roof 702 of the interior 720 of the reference vehicle platform, the camera sensor 704 on the roof 702, a driver seat 706, a passenger seat 708, a windshield 710, a steering wheel 712, and a dashboard 714 of the reference vehicle platform. In other examples, the interior 720 may not include everything shown in the interior 720 illustrated in FIG. 7A and/or may include other things that are not shown in the interior 720 illustrated in FIG. 7A such as, for example and without limitation, a display device (e.g., a screen such as a touchscreen, a liquid crystal display (LCD), a light-emitting diode (LED), a heads-up display, etc.), additional seats, different types of seats, one or more cup holders, one or more storage units, one or more dashboard components that are not shown in FIG. 7A, one or more vehicle controls, and/or any other objects, structures, components, and/or portions of the interior 720.

The camera sensor 704 in this example can include a camera sensor used to capture image data (e.g., images and video frames), such as the image 700 of the interior 720 of the reference vehicle platform associated with AV 102. The camera sensor 704 can be located in any location within the interior 720 of the reference vehicle platform. The camera sensor 704 can have a particular pose (e.g., location and orientation) within the interior 720 of the reference vehicle platform. In the illustrative example of FIG. 7A, the camera sensor 704 is located on the roof 702 of the interior 720 of the reference vehicle platform to provide an elevated or top-down view of a scene of the interior 720 of the reference vehicle platform (and/or components thereof), such as a birds-eye view of the interior 720 of the reference vehicle platform. However, in other examples, the camera sensor 704 can be located anywhere else within the interior 720 of the reference vehicle platform.

Based on the type of the camera sensor 704 and the pose of the camera sensor 704 within interior 720 of the reference vehicle platform (e.g., within the roof 702), the FOV of the camera sensor 704 can include the driver seat 706, the passenger seat 708, at least a portion of the windshield 710, at least a portion of the steering wheel 712, and at least a portion of the dashboard 714. However, in other implementations, the camera sensor on the interior 720 of the reference vehicle platform can be a different type of camera sensor (e.g., with different imaging capabilities such as focal length, different apertures, different lenses and/or lens capabilities (e.g., telephoto or zoom lens or lens capabilities, wide angle lens or wide angle lens capabilities, narrow angle lens or narrow angle lens capabilities, etc.), different color and/or lightning capabilities, etc.) and/or can have a different pose within the interior 720 of the reference vehicle platform than shown in FIG. 7A. Thus, in such examples, the FOV of such camera sensor may include one or more components (e.g., objects, structures, devices, etc.) within the interior 720 of the reference vehicle platform that are not included in the FOV of the camera sensor 704 and/or may not include one or more components that are within the FOV of the camera sensor 704 in FIG. 7A.

The configuration of the interior 720 of the reference vehicle platform can also impact what the image 700 captured by the camera sensor 704 can depict. For example, in FIG. 7A, the steering wheel 712 is within the FOV of the camera sensor 704 and the image 700 captured by the camera sensor 704 can depict the steering wheel 712. However, as further explained below, because the driver seat 706 and the passenger seat 708 of the reference vehicle platform are smaller than the corresponding driver and passenger seats of the target vehicle platform of the vehicle 725 in FIG. 7B (e.g., of the cabin of the AV 724 associated with the target vehicle platform), the steering wheel of the AV 725 is not within the FOV of the camera sensor on the roof of the AV 725 and thus the image captured by the camera sensor on the roof of the AV 725 does not depict the steering wheel of the AV 725.

FIG. 7B is a diagram illustrating another example image 730 of an interior 750 of a target vehicle platform associated with the AV 725. The image 730 was collected by a camera sensor 734 on the target vehicle platform. Thus, the image 730 is from the target vehicle platform. The image 730 can include a still image or a video frame, which can be part of a video including sequence of video frames. The target vehicle platform can describe, represent, and/or refer to the body type of the AV 725, the size of the AV 725, the shape of the AV 725, the dimensions of the AV 725, the configuration of the AV 725 (e.g., number and/or type of sensors, placement and/or pose of sensors, configuration of the interior 750 of the AV 725, the number and/or location of seats in the AV 725, the shape of the seats in the AV 725, etc.).

As previously noted, the image 730 includes image data captured by the camera sensor 734 on the interior 750 of the target vehicle platform. The interior 750 of the target vehicle platform (e.g., of the AV 725) can include, for example, an interior of a cabin (e.g., cabin system 138) of the AV 725 associated with the target vehicle platform. The image 730 can depict at least a portion of the interior 750 of the target vehicle platform, such as a scene in the interior 750 (e.g., inside of the cabin). In this example shown in FIG. 7B, the interior 750 of the target vehicle platform can include a roof 732 of the interior 750 of the target vehicle platform, the camera sensor 734 on the roof 732, a driver seat 736, a passenger seat 738, a windshield 740, and a dashboard 742 of the target vehicle platform. The interior 750 also includes a steering wheel. However, unlike FIG. 7A, in FIG. 7B, a view of the camera sensor 734 to the steering wheel is obstructed by a portion of the driver seat 736, which is wider than the driver seat 706 of the interior 750 of the target vehicle platform in FIG. 7A.

The structures, objects, and/or configuration of the interior 750 shown in FIG. 7B are merely illustrative examples provide for explanation purposes. In other examples, the interior 750 may have a different configuration than shown in FIG. 7B, may not include everything shown in the interior 750 illustrated in FIG. 7B, and/or may include other things that are not shown in the interior 750 illustrated in FIG. 7B such as, for example and without limitation, a display device (e.g., a screen such as a touchscreen, an LCD, an LED, a heads-up display, etc.), additional seats, different types of seats, one or more cup holders, one or more storage units, one or more dashboard components that are not shown in FIG. 7B, one or more vehicle controls, and/or any other objects, structures, components, and/or portions of the interior 750.

The camera sensor 734 in this example can include a camera sensor used to capture image data (e.g., images and video frames), such as the image 730 of the interior 750 of the target vehicle platform associated with AV 725. The camera sensor 734 can be located in any location within the interior 750 of the target vehicle platform. The camera sensor 734 can have a particular pose (e.g., location and orientation) within the interior 750 of the target vehicle platform. In the illustrative example of FIG. 7B, the camera sensor 734 is located on the roof 732 of the interior 750 of the target vehicle platform to provide an elevated or top-down view of a scene of the interior 750 of the target vehicle platform (and/or components thereof), such as a birds-eye view of the interior 750 of the target vehicle platform. However, in other examples, the camera sensor 734 can be located anywhere else within the interior 750 of the target vehicle platform.

Based on the type of the camera sensor 734 and the pose of the camera sensor 734 within interior 750 of the target vehicle platform (e.g., within the roof 732), the FOV of the camera sensor 734 can include the driver seat 736, the passenger seat 738, at least a portion of the windshield 740, and at least a portion of the dashboard 742. However, in other implementations, the camera sensor on the interior 750 of the target vehicle platform can be a different type of camera sensor (e.g., with different imaging capabilities such as focal length, different apertures, different lenses and/or lens capabilities (e.g., telephoto or zoom lens or lens capabilities, wide angle lens or wide angle lens capabilities, narrow angle lens or narrow angle lens capabilities, etc.), different color and/or lightning capabilities, etc.) and/or can have a different pose within the interior 750 of the target vehicle platform than shown in FIG. 7A. Thus, in such examples, the FOV of such camera sensor may include one or more components (e.g., objects, structures, devices, etc.) within the interior 750 of the target vehicle platform that are not included in the FOV of the camera sensor 734 and/or may not include one or more components that are within the FOV of the camera sensor 734 in FIG. 7B.

The configuration of the interior 750 of the target vehicle platform can also impact what the image 730 captured by the camera sensor 734 can depict. For example, unlike the image 700 illustrated in FIG. 7A, the image 730 captured by the camera sensor 734 in FIG. 7B does not include/depict the steering wheel of the vehicle platform (e.g., of AV 725) as the driver seat 736 in FIG. 7B is wider than the driver seat 706 in FIG. 7A, and blocks a view of the camera sensor 734 to the steering wheel. Thus, the steering wheel in this example represents an occlusion (e.g., something within a FOV of a sensor but otherwise occluded from a view of the sensor) as it is within the FOV of the camera sensor 734 but cannot be sensed (e.g., imaged, measured, detected, etc.) by the camera sensor 734 because it is occluded by the driver seat 736 from a view of the camera sensor 734. The driver seat 736 represents an occluding element as the driver seat 736 (e.g., a portion of the driver seat 736) is within a FOV of the camera sensor 734 but located relative to the camera sensor 734 and the steering wheel of the AV 725 such that it occludes (e.g., blocks, hides, etc.) the steering wheel from the camera sensor 734 (e.g., it blocks the view of the camera sensor 734 to the steering wheel and hides the steering wheel from the camera sensor 734).

FIG. 7C is a diagram illustrating a mapped image 760 that is mapped from the target vehicle platform associated with the interior 750 shown in FIG. 7B to the reference vehicle platform associated with the interior 702 shown in FIG. 7A.

The mapped image 760 can be generated by a GAN model (e.g., GAN model 306) based on the image 730 associated with the target vehicle platform. For example, the GAN model can generate the mapped image 760 by mapping the image 730 in FIG. 7B associated with the target vehicle platform to the image 700 in FIG. 7A associated with the reference vehicle platform. The mapped image 760 can be generated for processing by an AV model that is trained and configured for the reference vehicle platform associated with the image 700 shown in FIG. 7A. Thus, instead of creating a separate AV model for the target vehicle platform or retraining the AV model for the reference vehicle platform, the image 730 associated with the target vehicle platform can be mapped to the reference vehicle platform to yield the mapped image 760 that can be processed by the AV model trained for the reference vehicle platform.

As previously explained, the image 730 captured by the camera sensor 734 in FIG. 7B does not include/depict the steering wheel of the vehicle platform (e.g., of the target vehicle platform associated with the AV 725) as the driver seat 736 in FIG. 7B is wider than the driver seat 706 in FIG. 7A, and blocks a view of the camera sensor 734 to the steering wheel. However, images captured by the camera sensor 704 on the reference vehicle platform do include/depict the steering wheel, as illustrated in FIG. 7A. Thus, to map and/or conform the image 730 associated with the target vehicle platform to the reference vehicle platform, the mapped image 760 can adjust the width of the driver seat 736 based on the width of the driver seat 706 in the reference vehicle platform, to prevent the driver seat 736 from occluding the steering wheel 762 (or a portion thereof) in the target vehicle platform from a view of the camera sensor 734.

As shown, a boundary 764 of the driver seat 736 has been shifted to the adjusted boundary 766 so the steering wheel 762 is no longer occluded by the driver seat 736 from a view of the camera sensor 734. The adjusted boundary 766 of the driver seat 736 enables the steering wheel 762 to be visible to the camera sensor 734 from the pose of the camera sensor 734 on the roof 732 of the interior 750 of the target vehicle platform. Thus, once the boundary of the driver seat 736 has been shifted from the boundary 764 to the adjusted boundary 766, the steering wheel 762 can be depicted in the mapped image 732, consistent with the steering wheel being depicted in the image 700 associated with the reference vehicle platform.

In some examples, a GAN model (e.g., GAN model 306) can determine (e.g., based on images associated with the reference vehicle platform) that, unlike the driver seat in the target vehicle platform, the driver seat in the reference vehicle platform does not entirely occlude the steering wheel and the steering wheel is depicted in images captured by the camera sensor on the roof of the interior of the reference vehicle platform. Thus, the GAN model can adjust the boundary of the driver seat 736 in the image 760 from the boundary 764 of the driver seat 736 to the adjusted boundary 766, which allows the steering wheel 762 to be at least partially depicted in the image 760 associated with the target reference platform like the image 700 associated with the reference vehicle platform. In some examples, the GAN model can also generate the visible portion of the steering wheel 762 and add the visible portion of the steering wheel 762 to the mapped image 760, consistent with the images associated with the reference vehicle platform which depict a similar portion of the steering wheel on the reference vehicle platform.

In some examples, the GAN model can similarly adjust the width of the passenger seat 738 consistent with the width of the passenger seat in the reference vehicle platform. By adjusting the width of the passenger seat 738 to match the width of the passenger seat in the reference vehicle platform, the GAN model can increase a portion of the dashboard 742 and/or the windshield 740 that is/are no longer occluded by a portion of the passenger seat 738 and is now visible to the camera sensor 734. In some cases, if a particular element (e.g., object, structure, passenger, etc.) occluded in the image 730 associated with the target vehicle platform by the passenger seat 738 is otherwise visible in the image 700 associated with the reference vehicle platform, the GAN model can generate a synthetic version of the element and add it to the mapped image 760 generated by mapping the image 730 associated with the target vehicle platform to the reference vehicle platform. In some examples, the GAN model can add the element to the interior 732 at a respective location of the element in the reference vehicle platform (e.g., in the image 700 associated with the reference vehicle platform). After the GAN model adjusts the width of the passenger seat 738 and adds such element to the mapped image 760 as previously described with respect to the steering wheel 762, the element can be depicted in the mapped image 760.

After the image 730 associated with the target vehicle platform is mapped to the reference vehicle platform to generate the mapped image 760 mapped to the reference vehicle platform, the AV model trained for the reference vehicle platform can process the mapped image 760 as it processes other images collected from the reference vehicle platform. The AV model can process the mapped image 760 without retraining the AV model to handle images from the target vehicle platform. For example, the AV model may be trained to detect the steering wheel in the reference vehicle platform and perform calculations (e.g., predictions, tracking, localization, planning, etc.) using the visible portion of the steering wheel in images captured by the camera sensor on the roof. Since the steering wheel is occluded in the images captured by the image sensor in the target reference platform, the AV model may not be able to perform such calculations and/or may encounter errors, problems, and/or failures. However, the mapped image 760 does depict a portion of the steering wheel despite such image being generated based on the image 730 associated with the target vehicle platform. Thus, the mapped image 760 can include image data captured in the target reference platform but can conform to the reference vehicle platform. Accordingly, the AV model can use the mapped image 760 to detect the portion of the steering wheel and perform any calculations it is trained to perform using the portion of the steering wheel based on the images from the reference vehicle platform.

FIG. 8 is a flowchart illustrating an example process 800 for mapping data from a vehicle platform to a different vehicle platform. At block 802, the process 800 can include obtaining sensor data (e.g., sensor data 320) collected by an AV (e.g., AV 102, AV 725) in a scene. The AV can include a target vehicle platform. The target vehicle platform can define a body type of the AV, a size of the AV, a shape of the AV, a dimension(s) of the AV, a configuration of the AV, and/or one or more other attributes of the AV. The sensor data can describe, measure, and/or depict one or more elements in the scene. The one or more elements can include, for example, an object, a vehicle, a device, a person, a structure, and/or a condition.

At block 804, the process 800 can include determining one or more differences between the sensor data associated with the target vehicle platform and additional sensor data associated with a reference vehicle platform. In some examples, the reference vehicle platform can be associated with one or more software models (e.g., AV model 308) that are trained to process data from the reference vehicle platform.

At block 806, the process 800 can include mapping, based on the one or more differences, the sensor data associated with the target vehicle platform to the reference vehicle platform. In some examples, the mapping can be done via a machine learning model, such as a GAN model (e.g., GAN model 306), for example.

In some examples, mapping the sensor data associated with the target vehicle platform to the reference vehicle platform can include transferring a first attribute of the additional sensor data to the sensor data associated with the target vehicle platform and/or removing a second attribute of the additional sensor data from the sensor data associated with the target vehicle platform. In such examples, the one or more differences can include the first attribute and/or the second attribute.

In some cases, mapping the sensor data associated with the target vehicle platform to the reference vehicle platform can include determining that a first portion of the additional sensor data measures or depicts a scene element based on relative poses in space of the scene element scene and a sensor of the reference vehicle platform that captured the first portion of the additional sensor data that measures or depicts the scene element; determining that the sensor data associated with the target vehicle platform does not measure or depict the scene element; and modifying, via one or more machine learning models, the sensor data associated with the target vehicle platform to include a second portion of sensor data that measures or depicts the scene element. In some examples, the scene element can include an object, a structure, a device, at least a portion of a person, and/or a condition. The one or more differences can include the scene element measured or depicted in the first portion of the additional sensor data. Moreover, the second portion of sensor data can be generated by the one or more machine learning models, such as a GAN model.

In some cases, modifying the sensor data to include the second portion of sensor data can include removing, via the one or more machine learning models, a different element in the sensor data that occludes the scene element. In some examples, the different element can include a different object, a different device, a different structure, at least a portion of a different person, and/or a different condition. The different condition can include, for example, a lighting condition in the scene, a weather condition in the scene, sensor data noise, a brightness level of the sensor data, and/or an opacity level of one or more elements in the sensor data.

In some aspects, mapping the sensor data associated with the target vehicle platform to the reference vehicle platform can include determining that a portion of the sensor data associated with the target vehicle platform measures or depicts an element in the scene based on relative poses of the element in the scene and a sensor of the target vehicle platform that captured the portion of the sensor data that measures or depicts the element; determining that the additional sensor data associated with the reference vehicle platform does not measure or depict the element; and removing, via one or more machine learning models, the element from the sensor data associated with the target vehicle platform. In some examples, the element can include an object, a structure, a device, at least a portion of a person, and/or a condition.

In some cases, the one or more differences can include a difference in a first sensor perspective reflected in the sensor data and a second sensor perspective reflected in the additional sensor data, and mapping the sensor data associated with the target vehicle platform to the reference vehicle platform can include modifying the sensor data to reflect the second perspective reflected in the additional sensor data. In some examples, the difference in the first sensor perspective and the second sensor perspective can be based on a difference in a body type of the target vehicle platform and the reference vehicle platform, a difference in a size of the target vehicle platform and the reference vehicle platform, a difference in a shape of the target vehicle platform and the reference vehicle platform, a difference in dimensions of the target vehicle platform and the reference vehicle platform, a difference between a respective pose of one or more sensors that captured the sensor data relative to one or more portions of the target vehicle platform and a respective pose of one or more additional sensors that captured the additional sensor data relative to one or more portions of the reference vehicle platform, and/or a difference between a first pose of the one or more sensors in three-dimensional (3D) space and a second pose of the one or more additional sensors in 3D space.

At block 808, the process 800 can include processing the mapped sensor data via the one or more software models. As previously noted, in some cases, the one or more software models can be trained to process data from the reference vehicle platform. Thus, the one or more software models can process the mapped sensor data as it has been mapped to the reference vehicle platform.

In some examples, the sensor data can include data from a first type of sensor and the additional data can include data from a second type of sensor, and mapping the sensor data associated with the target vehicle platform to the reference vehicle platform can include mapping the data from the first type of sensor to the reference vehicle platform and the data from the second type of sensor. In some cases, the first type of sensor or the second type of sensor can include LIDAR sensor, a RADAR sensor, a camera sensor, an acoustic sensor, or a TOF sensor. Moreover, a different one of the first type of sensor or the second type of sensor can include a different one of the LIDAR sensor, the RADAR sensor, the camera sensor, the acoustic sensor, or the TOF sensor.

In some cases, the sensor data and the additional sensor data can include data from a same type of sensor. The same type of sensor can include, for example, a LIDAR sensor, a RADAR sensor, a camera sensor, an acoustic sensor, or a TOF sensor.

In some aspects, the sensor data can include data from a first type of sensor and the additional data can include fused data from a multiple types of sensors, and mapping the sensor data associated with the target vehicle platform to the reference vehicle platform can include mapping the data from the first type of sensor to the reference vehicle platform and the fused data from the multiple types of sensors. In other aspects, the sensor data can include fused data from multiple types of sensors and the additional data can include data from a first type of sensor, and mapping the sensor data associated with the target vehicle platform to the reference vehicle platform can include mapping the fused data from the multiple types of sensors to the reference vehicle platform and the data from the first type of sensor. In some examples, the multiple types of sensors can include a LIDAR sensor, a RADAR sensor, the camera sensor, the acoustic sensor, and/or the TOF sensor. In some examples, the first type of sensor can include a LIDAR sensor, a RADAR sensor, a camera sensor, a TOF sensor, or an acoustic sensor.

In some aspects, the process 800 can include generating simulation data (e.g., simulation data 310) that simulates a context of a first set of training data associated with the reference vehicle platform; based on the simulation data, modify a second set of training data associated with the reference vehicle platform to reflect the context of the first set of training data; and based on the first set of training data and the modified second set of training data, train one or more machine learning models to map the modified second set of training data associated with the target vehicle platform to the reference vehicle platform. In some examples, mapping the sensor data to the reference vehicle platform can be done via the one or more machine learning models.

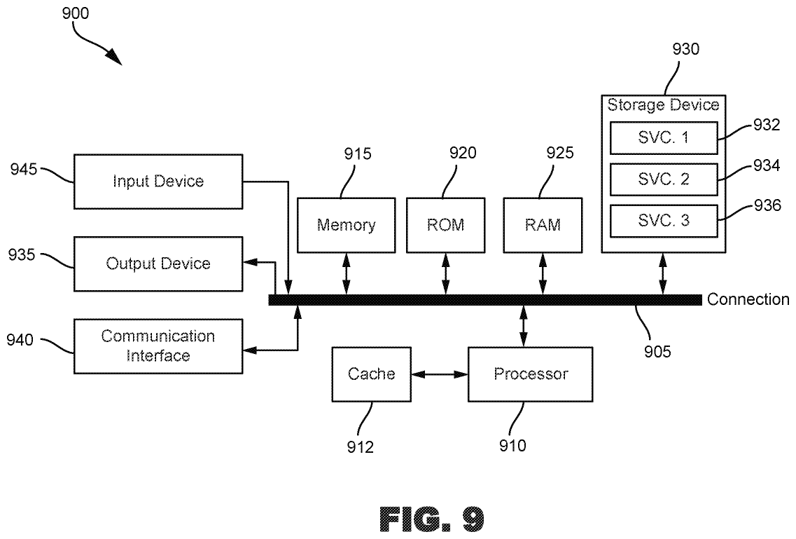

FIG. 9 illustrates an example processor-based system with which some aspects of the subject technology can be implemented. For example, processor-based system 900 can be any computing device making up local computing device 110, a remote computing device or system (e.g., data center 150), a passenger device (e.g., client computing device 170) executing the ridehailing application 172, or any component thereof in which the components of the system are in communication with each other using connection 905. Connection 905 can be a physical connection via a bus, or a direct connection into processor 910, such as in a chipset architecture. Connection 905 can also be a virtual connection, networked connection, or logical connection.

In some examples, computing system 900 is a distributed system in which the functions described in this disclosure can be distributed within a datacenter, multiple data centers, a peer network, etc. In some examples, one or more of the described system components represents many such components each performing some or all of the function for which the component is described. In some aspects, the components can be physical or virtual devices.

Example system 900 includes at least one processing unit (CPU or processor) 910 and connection 905 that couples various system components including system memory 915, such as read-only memory (ROM) 920 and random-access memory (RAM) 925 to processor 910. Computing system 900 can include a cache of high-speed memory 912 connected directly with, in close proximity to, and/or integrated as part of processor 910.

Processor 910 can include any general-purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 can include an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms known to those of skill in the art. In some instances, multimodal systems can enable a user to provide multiple types of input/output to communicate with computing system 900. Computing system 900 can include communications interface 940, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 902.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/9G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 can be a non-volatile and/or non-transitory computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L9/L #), resistive random-access memory (RRAM/ReRAM), phase change memory (PCM), spin transfer torque RAM (STT-RAM), another memory chip or cartridge, and/or a combination thereof.

Storage device 930 can include software services, servers, services, etc., that when the code that defines such software is executed by the processor 910, causes the system to perform a function. In some examples, a hardware service that performs a particular function can include the software component stored in a computer-readable medium in connection with the necessary hardware components, such as processor 910, connection 905, output device 935, etc., to carry out the function.

As understood by those of skill in the art, machine-learning techniques can vary depending on the desired implementation. For example, machine-learning schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

Aspects within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special-purpose computer, or special-purpose processing device to perform a certain function or group of functions. By way of example, computer-executable instructions can be used to implement perception system functionality for determining when sensor cleaning operations are needed or should begin. Computer-executable instructions can also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other examples of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Aspects of the disclosure may also be practiced in distributed computing environments where tasks are performed by local and remote processing devices that are linked (either by hardwired links, wireless links, or by a combination thereof) through a communications network. In a distributed computing environment, program modules can be located in both local and remote memory storage devices.

The various examples described above are provided by way of illustration only and should not be construed to limit the scope of the disclosure. For example, the principles herein apply equally to optimization as well as general improvements. Various modifications and changes may be made to the principles described herein without following the example aspects and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A system comprising: a memory; and one or more processors coupled to the memory, the one or more processors being configured to: obtain sensor data collected by an autonomous vehicle (AV) in a scene, the AV comprising a target vehicle platform, the sensor data describing, measuring, or depicting one or more elements in the scene; determine one or more differences between the sensor data associated with the target vehicle platform and additional sensor data associated with a reference vehicle platform, the reference vehicle platform being associated with one or more software models that are trained to process data from the reference vehicle platform; based on the one or more differences, map the sensor data associated with the target vehicle platform to the reference vehicle platform; and process the mapped sensor data via the one or more software models.

Aspect 2. The system of Aspect 1, wherein mapping the sensor data associated with the target vehicle platform to the reference vehicle platform comprises at least one of transferring a first attribute of the additional sensor data to the sensor data associated with the target vehicle platform and removing a second attribute of the additional sensor data from the sensor data associated with the target vehicle platform, and wherein the one or more differences comprises at least one of the first attribute and the second attribute.

Aspect 3. The system of any of Aspects 1 or 2, wherein mapping the sensor data associated with the target vehicle platform to the reference vehicle platform comprises: determining that a first portion of the additional sensor data measures or depicts a scene element based on relative poses in space of the scene element scene and a sensor of the reference vehicle platform that captured the first portion of the additional sensor data that measures or depicts the scene element, wherein the scene element comprises at least one of an object, a structure, a device, at least a portion of a person, and a condition; determining that the sensor data associated with the target vehicle platform does not measure or depict the scene element; and modifying, via one or more machine learning models, the sensor data associated with the target vehicle platform to include a second portion of sensor data that measures or depicts the scene element, wherein the one or more differences comprises the scene element measured or depicted in the first portion of the additional sensor data, and wherein the second portion of sensor data is generated by the one or more machine learning models.

Aspect 4. The system of any of Aspects 1 or 2, wherein modifying the sensor data to include the second portion of sensor data comprises removing, via the one or more machine learning models, a different element in the sensor data that occludes the scene element, the different element comprising at least one of a different object, a different device, a different structure, at least a portion of a different person, and a different condition, and wherein the different condition comprises at least one of a lighting condition in the scene, a weather condition in the scene, sensor data noise, a brightness level of the sensor data, and an opacity level of one or more elements in the sensor data.

Aspect 5. The system of any of Aspects 1 or 2, wherein mapping the sensor data associated with the target vehicle platform to the reference vehicle platform comprises: determining that a portion of the sensor data associated with the target vehicle platform measures or depicts an element in the scene based on relative poses of the element in the scene and a sensor of the target vehicle platform that captured the portion of the sensor data that measures or depicts the element, wherein the element comprises at least one of an object, a structure, a device, at least a portion of a person, and a condition; determining that the additional sensor data associated with the reference vehicle platform does not measure or depict the element; and removing, via one or more machine learning models, the element from the sensor data associated with the target vehicle platform.

Aspect 6. The system of any of Aspects 1 to 5, wherein the one or more differences comprises a difference in a first sensor perspective reflected in the sensor data and a second sensor perspective reflected in the additional sensor data, and wherein mapping the sensor data associated with the target vehicle platform to the reference vehicle platform comprises modifying the sensor data to reflect the second perspective reflected in the additional sensor data.

Aspect 7. The system of Aspect 6, wherein the difference in the first sensor perspective and the second sensor perspective is based on at least one of a difference in a body type of the target vehicle platform and the reference vehicle platform, a difference in a size of the target vehicle platform and the reference vehicle platform, a difference in a shape of the target vehicle platform and the reference vehicle platform, a difference in dimensions of the target vehicle platform and the reference vehicle platform, a difference between a respective pose of one or more sensors that captured the sensor data relative to one or more portions of the target vehicle platform and a respective pose of one or more additional sensors that captured the additional sensor data relative to one or more portions of the reference vehicle platform, and a difference between a first pose of the one or more sensors in three-dimensional (3D) space and a second pose of the one or more additional sensors in 3D space.

Aspect 8. The system of any of Aspects 1 to 7, wherein the sensor data comprises data from a first type of sensor and the additional data comprises data from a second type of sensor, wherein mapping the sensor data associated with the target vehicle platform to the reference vehicle platform comprises mapping the data from the first type of sensor to the reference vehicle platform and the data from the second type of sensor, wherein one of the first type of sensor or the second type of sensor comprises one of a light detection and ranging (LIDAR) sensor, a radio detection and ranging (RADAR) sensor, a camera sensor, an acoustic sensor, or a time-of-flight (TOF) sensor, and wherein a different one of the first type of sensor or the second type of sensor comprises a different one of the LIDAR sensor, the RADAR sensor, the camera sensor, the acoustic sensor, or the TOF sensor.

Aspect 9. The system of any of Aspects 1 to 7, wherein the sensor data comprises data from a first type of sensor and the additional data comprises fused data from a multiple types of sensors, wherein mapping the sensor data associated with the target vehicle platform to the reference vehicle platform comprises mapping the data from the first type of sensor to the reference vehicle platform and the fused data from the multiple types of sensors, wherein the multiple types of sensors comprise at least one of a light detection and ranging (LIDAR) sensor, a radio detection and ranging (RADAR) sensor, a camera sensor, an acoustic sensor, or a time-of-flight (TOF) sensor, and wherein a different one of the first type of sensor or the second type of sensor comprises a different one of the LIDAR sensor, the RADAR sensor, the camera sensor, the acoustic sensor, and the TOF sensor.

Aspect 10. The system of any of Aspects 1 to 9, wherein the one or more processors are configured to: generate simulation data that simulates a context of a first set of training data associated with the reference vehicle platform; based on the simulation data, modify a second set of training data associated with the reference vehicle platform to reflect the context of the first set of training data; and based on the first set of training data and the modified second set of training data, train one or more machine learning models to map the modified second set of training data associated with the target vehicle platform to the reference vehicle platform, wherein mapping the sensor data to the reference vehicle platform is done via the one or more machine learning models.

Aspect 11. A method comprising: obtaining sensor data collected by an autonomous vehicle (AV) in a scene, the AV comprising a target vehicle platform, the sensor data describing, measuring, or depicting one or more elements in the scene; determining one or more differences between the sensor data associated with the target vehicle platform and additional sensor data associated with a reference vehicle platform, the reference vehicle platform being associated with one or more software models that are trained to process data from the reference vehicle platform; based on the one or more differences, mapping the sensor data associated with the target vehicle platform to the reference vehicle platform; and processing the mapped sensor data via the one or more software models.

Aspect 12. The method of Aspect 11, wherein mapping the sensor data associated with the target vehicle platform to the reference vehicle platform comprises at least one of transferring a first attribute of the additional sensor data to the sensor data associated with the target vehicle platform and removing a second attribute of the additional sensor data from the sensor data associated with the target vehicle platform, and wherein the one or more differences comprises at least one of the first attribute and the second attribute.

Aspect 13. The method of any of Aspects 11 or 12, wherein mapping the sensor data associated with the target vehicle platform to the reference vehicle platform comprises: determining that a first portion of the additional sensor data measures or depicts a scene element based on relative poses in space of the scene element scene and a sensor of the reference vehicle platform that captured the first portion of the additional sensor data that measures or depicts the scene element, wherein the scene element comprises at least one of an object, a structure, a device, at least a portion of a person, and a condition; determining that the sensor data associated with the target vehicle platform does not measure or depict the scene element; and modifying, via one or more machine learning models, the sensor data associated with the target vehicle platform to include a second portion of sensor data that measures or depicts the scene element, wherein the one or more differences comprises the scene element measured or depicted in the first portion of the additional sensor data, and wherein the second portion of sensor data is generated by the one or more machine learning models.

Aspect 14. The method of any of Aspects 11 or 12, wherein modifying the sensor data to include the second portion of sensor data comprises removing, via the one or more machine learning models, a different element in the sensor data that occludes the scene element, the different element comprising at least one of a different object, a different device, a different structure, at least a portion of a different person, and a different condition, and wherein the different condition comprises at least one of a lighting condition in the scene, a weather condition in the scene, sensor data noise, a brightness level of the sensor data, and an opacity level of one or more elements in the sensor data.

Aspect 15. The method of any of Aspects 11 or 12, wherein mapping the sensor data associated with the target vehicle platform to the reference vehicle platform comprises: determining that a portion of the sensor data associated with the target vehicle platform measures or depicts an element in the scene based on relative poses of the element in the scene and a sensor of the target vehicle platform that captured the portion of the sensor data that measures or depicts the element, wherein the element comprises at least one of an object, a structure, a device, at least a portion of a person, and a condition; determining that the additional sensor data associated with the reference vehicle platform does not measure or depict the element; and removing, via one or more machine learning models, the element from the sensor data associated with the target vehicle platform.

Aspect 16. The method of any of Aspects 11 to 15, wherein the one or more differences comprises a difference in a first sensor perspective reflected in the sensor data and a second sensor perspective reflected in the additional sensor data.

Aspect 17. The method of Aspect 16, wherein mapping the sensor data associated with the target vehicle platform to the reference vehicle platform comprises modifying the sensor data to reflect the second perspective reflected in the additional sensor data.

Aspect 18. The method of any of Aspects 16 or 17, wherein the difference in the first sensor perspective and the second sensor perspective is based on at least one of a difference in a body type of the target vehicle platform and the reference vehicle platform, a difference in a size of the target vehicle platform and the reference vehicle platform, a difference in a shape of the target vehicle platform and the reference vehicle platform, a difference in dimensions of the target vehicle platform and the reference vehicle platform, and a difference between a respective pose of one or more sensors that captured the sensor data relative to one or more portions of the target vehicle platform and a respective pose of one or more additional sensors that captured the additional sensor data relative to one or more portions of the reference vehicle platform.

Aspect 19. The method of any of Aspects 11 to 18, wherein the sensor data comprises fused data from multiple types of sensors and the additional data comprises data from a first type of sensor, wherein mapping the sensor data associated with the target vehicle platform to the reference vehicle platform comprises mapping the fused data from the multiple types of sensors to the reference vehicle platform and the data from the first type of sensor.

Aspect 20. The method of Aspect 19, wherein the multiple types of sensors comprise at least one of a light detection and ranging (LIDAR) sensor, a radio detection and ranging (RADAR) sensor, a camera sensor, an acoustic sensor, or a time-of-flight (TOF) sensor, and wherein a different one of the first type of sensor or the second type of sensor comprises a different one of the LIDAR sensor, the RADAR sensor, the camera sensor, the acoustic sensor, and the TOF sensor.

Aspect 21. The method of any of Aspects 11 to 18, wherein the sensor data and the additional sensor data comprise data from at least one of a light detection and ranging (LIDAR) sensor, a radio detection and ranging (RADAR) sensor, a camera sensor, an acoustic sensor, or a time-of-flight (TOF) sensor, and wherein a different one of the first type of sensor or the second type of sensor comprises a different one of the LIDAR sensor, the RADAR sensor, the camera sensor, the acoustic sensor, and the TOF sensor.

Aspect 22. The method of any of Aspects 11 to 21, further comprising: generating simulation data that simulates a context of a first set of training data associated with the reference vehicle platform; based on the simulation data, modifying a second set of training data associated with the reference vehicle platform to reflect the context of the first set of training data; and based on the first set of training data and the modified second set of training data, training one or more machine learning models to map the modified second set of training data associated with the target vehicle platform to the reference vehicle platform, wherein mapping the sensor data to the reference vehicle platform is done via the one or more machine learning models.

Aspect 23. A non-transitory computer-readable medium having stored thereon instructions which, when executed by one or more processors, cause the one or more processors to perform a method according to any of Aspects 11 to 22.

Aspect 24. A system comprising means for performing a method according to any of Aspects 11 to 22.

Aspect 25. A computer-program product comprising instructions which, when executed by one or more processors, cause the one or more processors to perform a method according to any of Aspects 11 to 22.

Aspect 26. An autonomous vehicle comprising a computer device configured to perform a method according to any of Aspects 11 to 22.

What is claimed is:

1. A system comprising:
a memory; and
one or more processors coupled to the memory, the one or more processors being configured to:
obtain sensor data collected by an autonomous vehicle (AV) in a scene, the AV comprising a target vehicle platform, the sensor data describing, measuring, or depicting one or more elements in the scene;
determine one or more differences between the sensor data associated with the target vehicle platform and additional sensor data associated with a reference vehicle platform, the reference vehicle platform being associated with one or more software models that are trained to process data from the reference vehicle platform;
based on the one or more differences, map the sensor data associated with the target vehicle platform to the reference vehicle platform; and
process the mapped sensor data via the one or more software models.

2. The system of claim 1, wherein mapping the sensor data associated with the target vehicle platform to the reference vehicle platform comprises at least one of transferring a first attribute of the additional sensor data to the sensor data associated with the target vehicle platform and removing a second attribute of the additional sensor data from the sensor data associated with the target vehicle platform, and wherein the one or more differences comprises at least one of the first attribute and the second attribute.

3. The system of claim 1, wherein mapping the sensor data associated with the target vehicle platform to the reference vehicle platform comprises:
determining that a first portion of the additional sensor data measures or depicts a scene element based on relative poses in space of the scene element scene and a sensor of the reference vehicle platform that captured the first portion of the additional sensor data that measures or depicts the scene element, wherein the scene element comprises at least one of an object, a structure, a device, at least a portion of a person, and a condition;
determining that the sensor data associated with the target vehicle platform does not measure or depict the scene element; and
modifying, via one or more machine learning models, the sensor data associated with the target vehicle platform to include a second portion of sensor data that measures or depicts the scene element, wherein the one or more differences comprises the scene element measured or depicted in the first portion of the additional sensor data, and wherein the second portion of sensor data is generated by the one or more machine learning models.

4. The system of claim 1, wherein modifying the sensor data to include the second portion of sensor data comprises removing, via the one or more machine learning models, a different element in the sensor data that occludes the scene element, the different element comprising at least one of a different object, a different device, a different structure, at least a portion of a different person, and a different condition, and wherein the different condition comprises at least one of a lighting condition in the scene, a weather condition in the scene, sensor data noise, a brightness level of the sensor data, and an opacity level of one or more elements in the sensor data.

5. The system of claim 1, wherein mapping the sensor data associated with the target vehicle platform to the reference vehicle platform comprises:
determining that a portion of the sensor data associated with the target vehicle platform measures or depicts an element in the scene based on relative poses of the element in the scene and a sensor of the target vehicle platform that captured the portion of the sensor data that measures or depicts the element, wherein the element comprises at least one of an object, a structure, a device, at least a portion of a person, and a condition;
determining that the additional sensor data associated with the reference vehicle platform does not measure or depict the element; and
removing, via one or more machine learning models, the element from the sensor data associated with the target vehicle platform.

6. The system of claim 1, wherein the one or more differences comprises a difference in a first sensor perspective reflected in the sensor data and a second sensor perspective reflected in the additional sensor data, and wherein mapping the sensor data associated with the target vehicle platform to the reference vehicle platform comprises modifying the sensor data to reflect the second perspective reflected in the additional sensor data.

7. The system of claim 6, wherein the difference in the first sensor perspective and the second sensor perspective is based on at least one of a difference in a body type of the target vehicle platform and the reference vehicle platform, a difference in a size of the target vehicle platform and the reference vehicle platform, a difference in a shape of the target vehicle platform and the reference vehicle platform, a difference in dimensions of the target vehicle platform and the reference vehicle platform, a difference between a respective pose of one or more sensors that captured the sensor data relative to one or more portions of the target vehicle platform and a respective pose of one or more additional sensors that captured the additional sensor data relative to one or more portions of the reference vehicle platform, and a difference between a first pose of the one or more sensors in three-dimensional (3D) space and a second pose of the one or more additional sensors in 3D space.

8. The system of claim 1, wherein the sensor data comprises data from a first type of sensor and the additional data comprises data from a second type of sensor, wherein mapping the sensor data associated with the target vehicle platform to the reference vehicle platform comprises mapping the data from the first type of sensor to the reference vehicle platform and the data from the second type of sensor, wherein one of the first type of sensor or the second type of sensor comprises one of a light detection and ranging (LIDAR) sensor, a radio detection and ranging (RADAR) sensor, a camera sensor, an acoustic sensor, or a time-of-flight (TOF) sensor, and wherein a different one of the first type of sensor or the second type of sensor comprises a different one of the LIDAR sensor, the RADAR sensor, the camera sensor, the acoustic sensor, or the TOF sensor.

9. The system of claim 1, wherein the sensor data comprises data from a first type of sensor and the additional data comprises fused data from a multiple types of sensors, wherein mapping the sensor data associated with the target vehicle platform to the reference vehicle platform comprises mapping the data from the first type of sensor to the reference vehicle platform and the fused data from the multiple types of sensors, wherein the multiple types of sensors comprise at least one of a light detection and ranging (LIDAR) sensor, a radio detection and ranging (RADAR) sensor, a camera sensor, an acoustic sensor, or a time-of-flight (TOF) sensor, and wherein a different one of the first type of sensor or the second type of sensor comprises a different one of the LIDAR sensor, the RADAR sensor, the camera sensor, the acoustic sensor, and the TOF sensor.

10. The system of claim 1, wherein the one or more processors are configured to:
generate simulation data that simulates a context of a first set of training data associated with the reference vehicle platform;
based on the simulation data, modify a second set of training data associated with the reference vehicle platform to reflect the context of the first set of training data; and
based on the first set of training data and the modified second set of training data, train one or more machine learning models to map the modified second set of training data associated with the target vehicle platform to the reference vehicle platform, wherein mapping the sensor data to the reference vehicle platform is done via the one or more machine learning models.

11. A method comprising:
obtaining sensor data collected by an autonomous vehicle (AV) in a scene, the AV comprising a target vehicle platform, the sensor data describing, measuring, or depicting one or more elements in the scene;
determining one or more differences between the sensor data associated with the target vehicle platform and additional sensor data associated with a reference vehicle platform, the reference vehicle platform being associated with one or more software models that are trained to process data from the reference vehicle platform;
based on the one or more differences, mapping the sensor data associated with the target vehicle platform to the reference vehicle platform; and
processing the mapped sensor data via the one or more software models.

12. The method of claim 11, wherein mapping the sensor data associated with the target vehicle platform to the reference vehicle platform comprises at least one of transferring a first attribute of the additional sensor data to the sensor data associated with the target vehicle platform and removing a second attribute of the additional sensor data from the sensor data associated with the target vehicle platform, and wherein the one or more differences comprises at least one of the first attribute and the second attribute.

13. The method of claim 11, wherein mapping the sensor data associated with the target vehicle platform to the reference vehicle platform comprises:
determining that a first portion of the additional sensor data measures or depicts a scene element based on relative poses in space of the scene element scene and a sensor of the reference vehicle platform that captured the first portion of the additional sensor data that measures or depicts the scene element, wherein the scene element comprises at least one of an object, a structure, a device, at least a portion of a person, and a condition;
determining that the sensor data associated with the target vehicle platform does not measure or depict the scene element; and
modifying, via one or more machine learning models, the sensor data associated with the target vehicle platform to include a second portion of sensor data that measures or depicts the scene element, wherein the one or more differences comprises the scene element measured or depicted in the first portion of the additional sensor data, and wherein the second portion of sensor data is generated by the one or more machine learning models.

14. The method of claim 11, wherein modifying the sensor data to include the second portion of sensor data comprises removing, via the one or more machine learning models, a different element in the sensor data that occludes the scene element, the different element comprising at least one of a different object, a different device, a different structure, at least a portion of a different person, and a different condition, and wherein the different condition comprises at least one of a lighting condition in the scene, a weather condition in the scene, sensor data noise, a brightness level of the sensor data, and an opacity level of one or more elements in the sensor data.

15. The method of claim 11, wherein mapping the sensor data associated with the target vehicle platform to the reference vehicle platform comprises:
determining that a portion of the sensor data associated with the target vehicle platform measures or depicts an element in the scene based on relative poses of the element in the scene and a sensor of the target vehicle platform that captured the portion of the sensor data that measures or depicts the element, wherein the element comprises at least one of an object, a structure, a device, at least a portion of a person, and a condition;
determining that the additional sensor data associated with the reference vehicle platform does not measure or depict the element; and
removing, via one or more machine learning models, the element from the sensor data associated with the target vehicle platform.

16. The method of claim 11, wherein the one or more differences comprises a difference in a first sensor perspective reflected in the sensor data and a second sensor perspective reflected in the additional sensor data, wherein mapping the sensor data associated with the target vehicle platform to the reference vehicle platform comprises modifying the sensor data to reflect the second perspective reflected in the additional sensor data, wherein the difference in the first sensor perspective and the second sensor perspective is based on at least one of a difference in a body type of the target vehicle platform and the reference vehicle platform, a difference in a size of the target vehicle platform and the reference vehicle platform, a difference in a shape of the target vehicle platform and the reference vehicle platform, a difference in dimensions of the target vehicle platform and the reference vehicle platform, and a difference between a respective pose of one or more sensors that captured the sensor data relative to one or more portions of the target vehicle platform and a respective pose of one or more additional sensors that captured the additional sensor data relative to one or more portions of the reference vehicle platform.

17. The method of claim 11, wherein the sensor data comprises fused data from multiple types of sensors and the additional data comprises data from a first type of sensor, wherein mapping the sensor data associated with the target vehicle platform to the reference vehicle platform comprises mapping the fused data from the multiple types of sensors to the reference vehicle platform and the data from the first type of sensor, wherein the multiple types of sensors comprise at least one of a light detection and ranging (LIDAR) sensor, a radio detection and ranging (RADAR) sensor, a camera sensor, an acoustic sensor, or a time-of-flight (TOF) sensor, and wherein a different one of the first type of sensor or the second type of sensor comprises a different one of the LIDAR sensor, the RADAR sensor, the camera sensor, the acoustic sensor, and the TOF sensor.

18. The method of claim 11, wherein the sensor data and the additional sensor data comprise data from at least one of a light detection and ranging (LIDAR) sensor, a radio detection and ranging (RADAR) sensor, a camera sensor, an acoustic sensor, or a time-of-flight (TOF) sensor, and wherein a different one of the first type of sensor or the second type of sensor comprises a different one of the LIDAR sensor, the RADAR sensor, the camera sensor, the acoustic sensor, and the TOF sensor.

19. The method of claim 11, further comprising:
generating simulation data that simulates a context of a first set of training data associated with the reference vehicle platform;
based on the simulation data, modifying a second set of training data associated with the reference vehicle platform to reflect the context of the first set of training data; and
based on the first set of training data and the modified second set of training data, training one or more machine learning models to map the modified second set of training data associated with the target vehicle platform to the reference vehicle platform, wherein mapping the sensor data to the reference vehicle platform is done via the one or more machine learning models.

20. A non-transitory computer-readable medium having stored thereon instructions which, when executed by one or more processors, cause the one or more processors to:
obtain sensor data collected by an autonomous vehicle (AV) in a scene, the AV comprising a target vehicle platform, the sensor data describing, measuring, or depicting one or more elements in the scene;
determine one or more differences between the sensor data associated with the target vehicle platform and additional sensor data associated with a reference vehicle platform, the reference vehicle platform being associated with one or more software models that are trained to process data from the reference vehicle platform;
based on the one or more differences, map the sensor data associated with the target vehicle platform to the reference vehicle platform; and
process the mapped sensor data via the one or more software models.
